(19) United States
(12) Patent Application Publication
(10) Pub. No.: US 2025/0159706 A1
(43) Pub. Date: May 15, 2025

(54) METHODS AND APPARATUSES FOR CONTROL OF TERMINAL DEVICE

(71) Applicant: Telefonaktiebolaget LM Ericsson (publ), Stockholm (SE)

(72) Inventors: Muhammad Ali KAZMI, Reston, VA (US); Santhan THANGARASA, Vällingby (SE); Zhixen TANG, Täby (SE); Kazuyoshi UESAKA, Kawasaki Kanagawa (JP); Zhanxian WANG, Täby (SE)

(21) Appl. No.: 18/834,662

(22) PCT Filed: Feb. 13, 2023
(86) PCT No.: PCT/EP2023/053509

§ 371 Date: Jul. 31, 2024

(30) Foreign Application Priority Data
Feb. 14, 2022 (WO) PCT/CN2022/076238

(51) Int. Cl. H04W 72/51; H04L 5/00; H04W 72/0453

(52) U.S. Cl. CPC H04W 72/51; H04L 5/0048; H04W 72/0453

(57) ABSTRACT

Methods and apparatuses for control of terminal device are disclosed. According to an embodiment, a terminal device determines whether a first downlink bandwidth part (BWP) and a second downlink BWP are similar to each other in terms of radio configurations. The terminal device performs one or more uplink and/or downlink operational tasks based on a result of the determination.

### TECHNICAL FIELD

Embodiments of the disclosure generally relate to communication, and, more particularly, to methods and apparatuses for control of terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

Procedures and requirements to support reduced capability (Redcap) user equipment (UE), which entails characteristics like low complexity, low power consumption and low cost, are being specified in release 17 (Rel-17) of 3rd generation partnership project (3GPP). The use cases for new radio (NR) RedCap include wearables (e.g. smart watches, wearable medical devices, augmented reality (AR)/virtual reality (VR) goggles, etc.), industrial wireless sensors, and video surveillance. Therefore, the key requirements for RedCap UE are the battery lifetime and device size. A RedCap UE will support the following UE complexity reduction features.

The first feature is reduced maximum UE bandwidth. The maximum bandwidth of frequency range 1 (FR1) RedCap UE during and after initial access is 20 MHz. The maximum bandwidth of frequency range 2 (FR2) RedCap UE during and after initial access is 100 MHz.

The second feature is reduced minimum number of reception (Rx) branches. For frequency bands where a legacy NR UE is required to be equipped with a minimum of 2 Rx antenna ports, the minimum number of Rx branches supported by specification for a RedCap UE is 1. Note that the specification also supports 2 Rx branches for a RedCap UE in these bands. For frequency bands where a legacy NR UE (other than 2-Rx vehicular UE) is required to be equipped with a minimum of 4 Rx antenna ports, the minimum number of Rx branches supported by specification for a RedCap UE is 1. Note that the specification also supports 2 Rx branches for a RedCap UE in these bands.

The third feature is maximum number of downlink (DL) multiple input multiple output (MIMO) layers. For a RedCap UE with 1 Rx branch, 1 DL MIMO layer is supported. For a RedCap UE with 2 Rx branches, 2 DL MIMO layers are supported. The fourth feature is relaxed maximum modulation order. Support of 256 quadrature amplitude modulation (QAM) in DL is optional (instead of mandatory) for an FR1 RedCap UE. No other relaxations of maximum modulation order are specified for a RedCap UE. The fifth feature is duplex operation which may include frequency division duplex (FDD), half-duplex FDD (HD-FDD) and time division duplex (TDD).

A redcap capable UE may also be called as bandwidth reduced (BR) UE within the context of NR. A non-bandwidth reduced (non-BR) UE may refer to a legacy UE, which can operate on any bandwidth supported by certain frequency band. For example, a non-BR UE may operate on a bandwidth (BW) up to 40 MHz while a BR UE may operate on a BW up to 20 MHz in the same frequency band.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for control of terminal device. In particular, one of the problems to be solved by the disclosure is that the UE behavior for transmission of signals in non-initial bandwidth part (BWP) is unclear.

According to a first aspect of the disclosure, there is provided a method performed by a terminal device.

The method may comprise determining whether a first downlink BWP and a second downlink BWP are similar to each other in terms of radio configurations. The method may further comprise performing one or more uplink and/or downlink operational tasks based on a result of the determination.

In this way, it is possible to improve the performance of the terminal device in the case of multiple BWPs.

In an embodiment of the disclosure, the one or more uplink operational tasks may be performed within a bandwidth of a second uplink BWP associated with the second downlink BWP, or a first uplink BWP associated with the first downlink BWP, based on the result of the determination.

In an embodiment of the disclosure, the one or more downlink operational tasks may be performed within a bandwidth of the first downlink BWP and/or the second downlink BWP, based on the result of the determination.

In an embodiment of the disclosure, a bandwidth of the first downlink BWP may contain a first reference signal (RS), and a bandwidth of the second downlink BWP may contain a second RS. Alternatively, the bandwidth of the first downlink BWP may contain the first RS, and the bandwidth of the second downlink BWP may contain no RS.

In an embodiment of the disclosure, the first downlink BWP and the second downlink BWP may be determined to be similar to each other when at least one of following conditions is satisfied: a bandwidth of the first downlink BWP and a bandwidth of the second downlink BWP at least partially overlap with each other in frequency domain; the bandwidth of the first downlink BWP and the bandwidth of the second downlink BWP are close to each other in frequency domain; a first RS is transmitted within the bandwidth of the first downlink BWP and a second RS is transmitted within the bandwidth of the second downlink BWP; a difference between transmission powers of the first RS and the second RS is within a predetermined threshold power; the difference between transmission powers of the first RS and the second RS is known to the terminal device; a transmission periodicity of the first RS and a transmission periodicity of the second RS are the same; and a difference between the transmission periodicities of the first RS and the second RS is less than or equal to a predetermined threshold time.

In an embodiment of the disclosure, the bandwidth of the first downlink BWP and the bandwidth of the second downlink BWP may be close to each other in frequency domain, when at least one of following conditions is satisfied: a difference in frequency between the first downlink BWP and the second downlink BWP is within a first predetermined threshold; the difference in frequency between the first downlink BWP and the second downlink BWP is not larger than a second predetermined threshold; a difference between a frequency related to the first downlink BWP and a frequency related to the second downlink BWP is less than or equal to a third predetermined threshold; a distance in frequency between the first RS and the second RS is within a fourth predetermined threshold; the distance in frequency between the first RS and the second RS is not larger than a fifth predetermined threshold; and a difference between a frequency related to the first RS and a frequency related to the second RS is less than or equal to a sixth predetermined threshold.

In an embodiment of the disclosure, the frequency related to the first downlink BWP may be a start/end/center frequency of the first downlink BWP, and the frequency related to the second downlink BWP may be a start/end/center frequency of the second downlink BWP. The frequency related to the first RS may be a start/end/center frequency of the first RS, and the frequency related to the second RS may be a start/end/center frequency of the second RS.

In an embodiment of the disclosure, each of the predetermined threshold power, the predetermined threshold time, and the first to sixth predetermined thresholds may be configured by a network node or predefined in the terminal device.

In an embodiment of the disclosure, whether the first downlink BWP and the second downlink BWP are similar to each other may be determined periodically or in response to a trigger.

In an embodiment of the disclosure, a first set of uplink operational tasks may be performed when determining that the first downlink BWP and the second downlink BWP are similar to each other. The first set of uplink operational tasks may comprise at least one of: transmitting an uplink signal within the bandwidth of the second uplink BWP without measuring a second RS contained in a bandwidth of the second downlink BWP; transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other; performing a component of a second predetermined procedure within a third time period, wherein the third time period is shorter than a fourth time period within which the same component of the same second predetermined procedure is performed in a case where the first downlink BWP and the second downlink BWP are not similar to each other; using one of the first RS and the second RS for acquiring timing for transmitting an uplink signal within the bandwidth of the second uplink BWP; using the first RS for acquire timing for transmitting an uplink signal within the bandwidth of the second uplink BWP if the second downlink BWP does not contain the second RS; and transmitting an uplink signal within the bandwidth of the second uplink BWP even if the second downlink BWP does not contain the second RS.

In an embodiment of the disclosure, a second set of uplink operational tasks may be performed when determining that the first downlink BWP and the second downlink BWP are not similar to each other. The second set of uplink operational tasks may comprise at least one of discarding a transmission of an uplink signal within the bandwidth of the second uplink BWP; postponing a transmission of an uplink signal within the bandwidth of the second uplink BWP; transmitting an uplink signal within a bandwidth of a different uplink BWP than the second uplink BWP; transmitting an uplink signal within the bandwidth of the second uplink BWP after measuring a second RS contained in a bandwidth of the second downlink BWP or a first RS contained in a bandwidth of the first downlink BWP; transmitting an uplink signal or performing a first predetermined procedure containing the transmission of the uplink signal, within the bandwidth of the second uplink BWP within a second time period, wherein the second time period is longer than a first time period within which the same uplink signal is transmitted or the same first predetermined procedure is performed in a case where the first downlink BWP and the second downlink BWP are similar to each other; performing a component of a second predetermined procedure within a fourth time period, wherein the fourth time period is longer than a third time period within which the same component of the same second predetermined procedure is performed in a case where the first downlink BWP and the second downlink BWP are similar to each other; using the second RS for acquiring timing for transmitting an uplink signal within the bandwidth of the second uplink BWP; and discarding or postponing a transmission of an uplink signal within the bandwidth of the second uplink BWP if the second downlink BWP does not contain the second RS.

In an embodiment of the disclosure, a first set of downlink operational tasks may be performed when determining that the first downlink BWP and the second downlink BWP are similar to each other. The first set of downlink operational tasks may comprise at least one of performing serving cell measurements based on one of the first RS and the second RS which is within an active BWP, when serving cell measurements on the first RS and the second RS are configured to the terminal device; performing neighbor cell measurements based on one of the first RS and the second RS which does not have measurements gaps, when neighbor cell measurements on the first RS and the second RS are configured to the terminal device; and performing neighbor cell measurements based on one of the first RS and the second RS, when neighbor cell measurements on the first RS and the second RS are configured to the terminal device and both the first RS and the second RS have measurements gaps.

In an embodiment of the disclosure, a second set of downlink operational tasks may be performed when determining that the first downlink BWP and the second downlink BWP are not similar to each other. The second set of downlink operational tasks may comprise at least one of: performing serving cell measurements based on both the first RS and the second RS, when serving cell measurements on the first RS and the second RS are configured to the terminal device; and performing neighbor cell measurements based on both the first RS and the second RS, when neighbor cell measurements on the first RS and the second RS are configured to the terminal device.

In an embodiment of the disclosure, the one or more uplink or downlink operational tasks may be configured by a network node or predefined in the terminal device.

In an embodiment of the disclosure, the first downlink BWP may be an initial downlink BWP, and the second downlink BWP may be a non-initial downlink BWP. The first downlink BWP may be an initial downlink BWP, and the second downlink BWP may be a reduced capability (Redcap) downlink BWP.

In an embodiment of the disclosure, the first uplink BWP may be an initial uplink BWP, and the second uplink BWP may be a non-initial uplink BWP. Alternatively, the first uplink BWP may be an initial uplink BWP, and the second uplink BWP may be a Redcap uplink BWP.

In an embodiment of the disclosure, each of the first RS and the second RS may be a synchronization signal block (SSB). Alternatively, the first RS may be a cell-defining SSB (CD-SSB), and the second RS may be a non-cell-defining SSB (NCD-SSB). Alternatively, the first RS may be a channel state information reference signal (CSI-RS), and the second RS may be an NCD-SSB.

In an embodiment of the disclosure, the method may further comprise providing user data and forwarding the user data to a host computer via the transmission to the base station.

According to a second aspect of the disclosure, there is provided a method performed by a network node. The method may comprise transmitting, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In this way, it is possible to allow the performance of the terminal device to be improved in the case of multiple BWPs.

In an embodiment of the disclosure, the one or more uplink operational tasks are to be performed within a bandwidth of a second uplink BWP associated with the second downlink BWP, or a first uplink BWP associated with the first downlink BWP.

In an embodiment of the disclosure, a bandwidth of the first downlink BWP may contain a first RS, and a bandwidth of the second downlink BWP may contain a second RS. Alternatively, the bandwidth of the first downlink BWP may contain the first RS, and the bandwidth of the second downlink BWP may contain no RS.

In an embodiment of the disclosure, the at least one condition may comprise one or more of a bandwidth of the first downlink BWP and a bandwidth of the second downlink BWP at least partially overlap with each other in frequency domain; the bandwidth of the first downlink BWP and the bandwidth of the second downlink BWP are close to each other in frequency domain; a first RS is transmitted within the bandwidth of the first downlink BWP and a second RS is transmitted within the bandwidth of the second downlink BWP; a difference between transmission powers of the first RS and the second RS is within a predetermined threshold power; the difference between transmission powers of the first RS and the second RS is known to the terminal device; a transmission periodicity of the first RS and a transmission periodicity of the second RS are the same; and a difference between the transmission periodicities of the first RS and the second RS is less than or equal to a predetermined threshold time.

In an embodiment of the disclosure, the bandwidth of the first downlink BWP and the bandwidth of the second downlink BWP may be close to each other in frequency domain, when at least one of following conditions is satisfied: a difference in frequency between the first downlink BWP and the second downlink BWP is within a first predetermined threshold; the difference in frequency between the first downlink BWP and the second downlink BWP is not larger than a second predetermined threshold; a difference between a frequency related to the first downlink BWP and a frequency related to the second downlink BWP is less than or equal to a third predetermined threshold; a distance in frequency between the first RS and the second RS is within a fourth predetermined threshold; the distance in frequency between the first RS and the second RS is not larger than a fifth predetermined threshold; and a difference between a frequency related to the first RS and a frequency related to the second RS is less than or equal to a sixth predetermined threshold.

In an embodiment of the disclosure, the frequency related to the first downlink BWP may be a start/end/center frequency of the first downlink BWP, and the frequency related to the second downlink BWP may be a start/end/center frequency of the second downlink BWP. The frequency related to the first RS may be a start/end/center frequency of the first RS, and the frequency related to the second RS may be a start/end/center frequency of the second RS.

In an embodiment of the disclosure, the one or more uplink operational tasks to be performed when the first downlink BWP and the second downlink BWP are similar to each other, may comprise at least one of transmitting an uplink signal within the bandwidth of the second uplink BWP without measuring a second RS contained in a bandwidth of the second downlink BWP; transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other; performing a component of a second predetermined procedure within a third time period, wherein the third time period is shorter than a fourth time period within which the same component of the same second predetermined procedure is performed in a case where the first downlink BWP and the second downlink BWP are not similar to each other; using one of the first RS and the second RS for acquiring timing for transmitting an uplink signal within the bandwidth of the second uplink BWP; using the first RS for acquire timing for transmitting an uplink signal within the bandwidth of the second uplink BWP if the second downlink BWP does not contain the second RS; and transmitting an uplink signal within the bandwidth of the second uplink BWP even if the second downlink BWP does not contain the second RS.

In an embodiment of the disclosure, the one or more uplink operational tasks to be performed when the first downlink BWP and the second downlink BWP are not similar to each other, may comprise at least one of: discarding a transmission of an uplink signal within the bandwidth of the second uplink BWP; postponing a transmission of an uplink signal within the bandwidth of the second uplink BWP; transmitting an uplink signal within a bandwidth of a different uplink BWP than the second uplink BWP; transmitting an uplink signal within the bandwidth of the second uplink BWP after measuring a second RS contained in a bandwidth of the second downlink BWP or a first RS contained in a bandwidth of the first downlink BWP; transmitting an uplink signal or performing a first predetermined procedure containing the transmission of the uplink signal, within the bandwidth of the second uplink BWP within a second time period, wherein the second time period is longer than a first time period within which the same uplink signal is transmitted or the same first predetermined procedure is performed in a case where the first downlink BWP and the second downlink BWP are similar to each other; performing a component of a second predetermined procedure within a fourth time period, wherein the fourth time period is longer than a third time period within which the same component of the same second predetermined procedure is performed in a case where the first downlink BWP and the second downlink BWP are similar to each other; using the second RS for acquiring timing for transmitting an uplink signal within the bandwidth of the second uplink BWP; and discarding or postponing a transmission of an uplink signal within the bandwidth of the second uplink BWP if the second downlink BWP does not contain the second RS.

In an embodiment of the disclosure, the one or more downlink operational tasks to be performed when the first downlink BWP and the second downlink BWP are similar to each other, may comprise at least one of: performing serving cell measurements based on one of the first RS and the second RS which is within an active BWP, when serving cell measurements on the first RS and the second RS are configured to the terminal device; performing neighbor cell measurements based on one of the first RS and the second RS which does not have measurements gaps, when neighbor cell measurements on the first RS and the second RS are configured to the terminal device; and performing neighbor cell measurements based on one of the first RS and the second RS, when neighbor cell measurements on the first RS and the second RS are configured to the terminal device and both the first RS and the second RS have measurements gaps.

In an embodiment of the disclosure, the one or more downlink operational tasks to be performed when the first downlink BWP and the second downlink BWP are not similar to each other, may comprise at least one of: performing serving cell measurements based on both the first RS and the second RS, when serving cell measurements on the first RS and the second RS are configured to the terminal device; and performing neighbor cell measurements based on both the first RS and the second RS, when neighbor cell measurements on the first RS and the second RS are configured to the terminal device.

In an embodiment of the disclosure, the first downlink BWP may be an initial downlink BWP, and the second downlink BWP may be a non-initial downlink BWP. Alternatively, the first downlink BWP may be an initial downlink BWP, and the second downlink BWP may be a Redcap downlink BWP.

In an embodiment of the disclosure, the first uplink BWP may be an initial uplink BWP, and the second uplink BWP may be a non-initial uplink BWP. Alternatively, the first uplink BWP may be an initial uplink BWP, and the second uplink BWP may be a Redcap uplink BWP.

In an embodiment of the disclosure, each of the first RS and the second RS may be an SSB. Alternatively, the first RS may be a CD-SSB, and the second RS may be an NCD-SSB. Alternatively, the first RS may be a CSI-RS, and the second RS may be an NCD-SSB.

According to a third aspect of the disclosure, there is provided a terminal device. The terminal device may comprise at least one processor and at least one memory. The at least one memory may contain instructions executable by the at least one processor, whereby the terminal device may be operative to determine whether a first downlink BWP and a second downlink BWP are similar to each other in terms of radio configurations. The terminal device may be further operative to perform one or more uplink and/or downlink operational tasks based on a result of the determination.

In an embodiment of the disclosure, the terminal device may be operative to perform the method according to the above first aspect.

According to a fourth aspect of the disclosure, there is provided a network node. The network node may comprise at least one processor and at least one memory. The at least one memory may contain instructions executable by the at least one processor, whereby the network node may be operative to transmit, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In an embodiment of the disclosure, the network node may be operative to perform the method according to the above second aspect.

According to a fifth aspect of the disclosure, there is provided a computer program product. The computer program product may comprise instructions which when executed by at least one processor, cause the at least one processor to perform the method according to any of the above first and second aspects.

According to a sixth aspect of the disclosure, there is provided a computer readable storage medium. The computer readable storage medium may store thereon instructions which when executed by at least one processor, cause the at least one processor to perform the method according to any of the above first and second aspects.

According to a seventh aspect of the disclosure, there is provided a terminal device. The terminal device may comprise a determination module for determining whether a first downlink BWP and a second downlink BWP are similar to each other in terms of radio configurations. The terminal device may further comprise a performing module for performing one or more uplink and/or downlink operational tasks based on a result of the determination.

According to an eighth aspect of the disclosure, there is provided a network node. The network node may comprise a transmission module for transmitting, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

According to a ninth aspect of the disclosure, there is provided a method implemented in a communication system including a network node and a terminal device. The method may comprise steps of the method according to the above first aspect and steps of the method according to the above second aspect.

According to a tenth aspect of the disclosure, there is provided a communication system including a terminal device according to the above third or seventh aspect and a network node according to the above fourth or eighth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating examples of active BWP switching;

FIG. 2A is a diagram illustrating 4-step random access procedure;

FIG. 2B is a diagram illustrating 2-step random access procedure;

FIG. 3 is a diagram illustrating an example of UL/DL resources for UE in IDLE/INACTIVE mode;

FIG. 4 is a diagram illustrating examples of initial and non-initial BWPs configured within cell bandwidth;

FIG. 5 is a flowchart illustrating a method performed by a terminal device according to an embodiment of the disclosure;

FIG. 6 is a flowchart illustrating a method performed by a network node according to an embodiment of the disclosure;

FIG. 7A is a diagram illustrating serving cell active BWP with CD-SSB for performing measurements for RedCap UE;

FIG. 7B is a diagram illustrating serving cell active BWP with NCD-SSB for performing measurements for RedCap UE;

FIG. 7C is a diagram illustrating serving cell active BWP without SSB for performing measurements for RedCap UE;

FIG. 8 is a block diagram showing an apparatus suitable for use in practicing some embodiments of the disclosure;

FIG. 9 is a block diagram showing a terminal device according to an embodiment of the disclosure;

FIG. 10 is a block diagram showing a network node according to an embodiment of the disclosure;

FIG. 11 is diagram illustrating an example of a communication system in accordance with some embodiments;

FIG. 12 is a diagram illustrating a UE in accordance with some embodiments;

FIG. 13 is a diagram illustrating a network node in accordance with some embodiments;

FIG. 14 is a diagram illustrating a host in accordance with some embodiments;

FIG. 15 is a diagram illustrating a virtualization environment in which functions implemented by some embodiments may be virtualized;

FIG. 16 is a diagram illustrating a host communicating via a network node with a UE over a partially wireless connection in accordance with some embodiments;

FIG. 17 is a flowchart illustrating a method implemented in a communication system in accordance with some embodiments;

FIG. 18 is a flowchart illustrating a method implemented in a communication system in accordance with some embodiments;

FIG. 19 is a flowchart illustrating a method implemented in a communication system in accordance with some embodiments; and

FIG. 20 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The UE can be configured by the higher layer with a set of bandwidth parts (BWPs) for signal receptions (e.g. physical downlink control channel (PDCCH), physical downlink shared channel (PDSCH), etc.) by the UE (DL BWP set e.g. up to 4 DL BWPs) and a set of BWPs for signal transmissions (e.g. physical uplink control channel (PUCCH), physical uplink shared channel (PUSCH)) by the UE (uplink (UL) BWP set e.g. up to 4 UL BWPs) in a serving cell e.g. SpCell (e.g. primary cell (Pcell), primary secondary cell (PSCell)), secondary cell (Scell), etc. Each BWP can be associated with multiple parameters. Examples of such parameters are: BW (e.g. number of time-frequency resources (e.g. resource blocks such as 25 physical resource blocks (PRBs), etc.), location of BWP in frequency (e.g. starting resource block (RB) index of BWP or center frequency, etc.), subcarrier spacing (SCS), cyclic prefix (CP) length, any other baseband parameter (e.g. MIMO layer, receivers, transmitters, hybrid automatic repeat request (HARQ) related parameters etc.), etc.

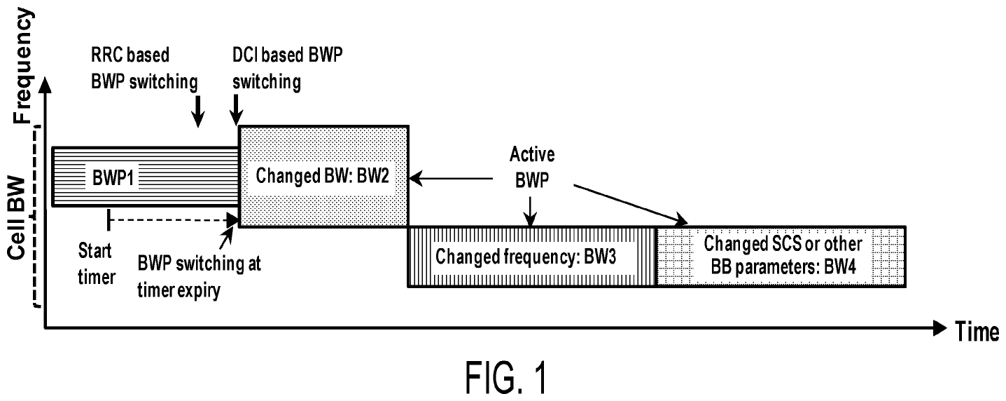

The UE is served (e.g. receives signals such as PDCCH, PDSCH and transmits signals such as PUCCH, PUSCH) in a serving cell only on the active BWP(s). At least one of the configured DL BWPs can be active for reception and at least one of the configured UL BWPs can be active for transmission in each serving cell. The UE can be configured to switch the active BWP based on a timer (e.g. BWP inactivity timer such as bwp-InactivityTimer), by receiving a command or a message from another node (e.g. from the base station (BS)), or autonomously by the UE, etc. Any active BWP can be switched independently, e.g. UL and DL active BWPs can be switched separately. The active BWP switching operation may involve change in one or more parameters associated with the BWP described above, e.g. BW, frequency location, SCS, etc.). An example of the active BWP switching is illustrated in FIG. 1. For example, the UE is configured with 4 different BWPs: BWP1, BWP2, BWP3 and BWP4, which are associated with different set of parameters e.g. BW, SCS, frequency location, etc. The UE can be configured to switch its active BWP based on any of timer, downlink control information (DCI) command or radio resource control (RRC) message (which also includes RRC procedure delay e.g. 10 ms). For example, the UE is switched first from the current active BWP1 to new BWP2, which becomes new active BWP. The active BWP2 is further switched to BWP3, which in turn becomes new active BWP. The active BWP3 is then further switched to BWP4, which in turn becomes new active BWP. The active BWP switching involves delay e.g. X number of slots. The switching delay depends on one or multiple factors e.g. type of BWP switching, numerology of BWP before and after the switching, number of serving cells on which the BWP switching is triggered simultaneously, number of serving cells on which the BWP switching is triggered non-simultaneously (e.g. over partially overlapping time periods), etc.

Initial BWP is used by the UE at least during the initial access. The information about the first initial DL BWP is provided in system information (e.g. master information block (MIB) in control-resource set (CORESET) #0 (which is known as MIB-configured initial DL BWP)). After reception of CORESET #0 and decoding system information block 1 (SIB1), a UE can have the configuration of a SIB-configured initial DL BWP. Specifically, the BWP configuration (IE initialDownlinkBWP) provides information about the bandwidth and location of the initial DL BWP, subcarrier spacing, and cell-specific PDCCH and PDSCH parameters of the BWP. To efficiently support UEs with different capabilities (e.g., bandwidth) in the same cell, procedures to enable coexistence of different UEs (e.g., RedCap UEs and non-RedCap or legacy UEs) are being specified. In this regard, separate SIB-configured initial DL BWPs for RedCap and non-RedCap UEs and separate non-initial BWP for redcap UEs are being specified.

The UE performs measurements on one or more DL and/or UL reference signal (RS) of one or more cells in different UE activity states e.g. RRC idle state, RRC inactive state, RRC connected state, etc. The measured cell may belong to or operate on the same carrier frequency as of the serving cell (e.g. intra-frequency carrier) or it may belong to or operate on different carrier frequency as of the serving cell (e.g. non-serving carrier frequency). The non-serving carrier may be called as inter-frequency carrier if the serving and measured cells belong to the same radio access technology (RAT) but different carriers. The non-serving carrier may be called as inter-RAT carrier if the serving and measured cells belong to different RATs. Examples of downlink RS are signals in synchronization signal block (SSB), channel state information reference signal (CSI-RS), cell reference signal (CRS), demodulation reference signal (DMRS), primary synchronization signal (PSS), secondary synchronization signal (SSS), signals in synchronization signal/physical broadcast channel (SS/PBCH) block, discovery reference signal (DRS), positioning reference signal (PRS), etc. Examples of uplink RS are signals in sounding reference signal (SRS), DMRS, etc.

Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's system frame number (SFN)), etc. Therefore, SMTC occasion may also occur with certain periodicity e.g. 5 ms, 10 ms, 20 ms, 40 ms, 80 ms and 160 ms.

Examples of measurements are cell identification (e.g. physical cell identifier (PCI) acquisition, PSS/SSS detection, cell detection, cell search, etc.), reference symbol received power (RSRP), reference symbol received quality (RSRQ), secondary synchronization RSRP (SS-RSRP), SS-RSRQ, signal to interference and noise ratio (SINR), RS-SINR, SS-SINR, CSI-RSRP, CSI-RSRQ, received signal strength indicator (RSSI), acquisition of system information (SI), cell global ID (CGI) acquisition, reference signal time difference (RSTD), UE reception-transmission (RX-TX) time difference measurement, radio link monitoring (RLM), which consists of Out of Synchronization (out of sync) detection and In Synchronization (in-sync) detection, etc.

The UE is typically configured by the network (e.g. via RRC message) with measurement and measurement reporting configurations, e.g. measurement gap pattern, carrier frequency information, types of measurements (e.g. RSRP etc.), higher layer filtering coefficient, time to trigger report, reporting mechanism (e.g. periodic, event triggered reporting, event triggered periodic reporting, etc.), etc. The measurements are done for various purposes. Some example measurement purposes are: UE mobility (e.g. cell change etc.), UE positioning, self-organizing network (SON), minimization of drive tests (MDT), operation and maintenance (O&M), network planning and optimization, etc.

To support redcap UEs, a cell transmits at least cell-defining SSB (CD-SSB) and it may also transmit non-cell-defining SSB (NCD-SSB). When an SSB is associated with a remaining minimum system information (RMSI), the SSB is referred to as a CD-SSB. A PCell is always associated to a CD-SSB located on the synchronization raster. If a separate initial/RRC configured DL BWP is configured to contain the entire CORESET #0, CD-SSB is expected by RedCap UE. NCD-SSB which is not associated with CORESET #0 is mainly used for some procedures, e.g. performing measurements. For a separate initial DL BWP (if it does not include CD-SSB and the entire CORESET #0), if it is configured for paging, RedCap UE expects it to contain NCD-SSB for serving cell but not CORESET #0/SIB. For an RRC-configured active DL BWP in connected mode (if it does not include CD-SSB and the entire CORESET #0), a RedCap UE supporting mandatory FG 6-1 (but not optional FG 6-1a) expects it to contain NCD-SSB for serving cell but not CORESET #0/SIB.

In NR, the UE may be configured by the network to transmit random access (RA) in a cell (e.g. serving cell or a neighbor cell) using 4-step RA procedure and/or using 2-step RA procedure.

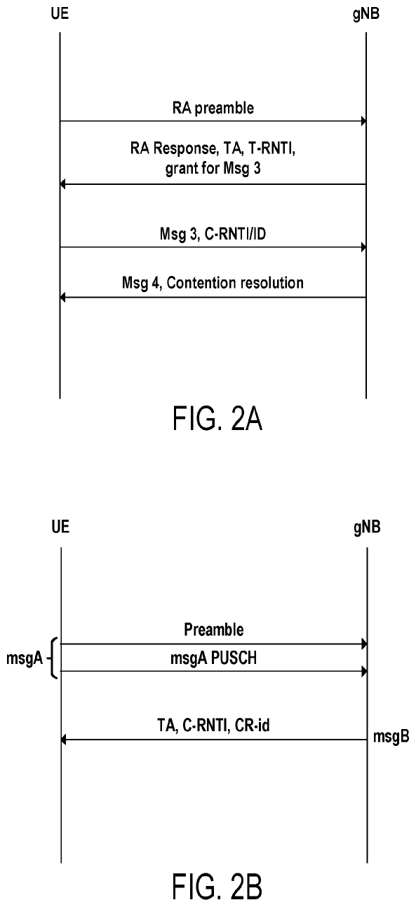

The principle of the 4-step RA type procedure in NR is shown in FIG. 2A. It involves 4 steps each comprising one message (UL or DL). At step 1 (preamble transmission), the UE randomly selects a RA preamble (PREAMBLE_INDEX) corresponding to a selected SS/PBCH block, transmits the preamble on the physical random access channel (PRACH) occasion mapped by the selected SS/PBCH block. When the base station (BS) (e.g. a next generation node B or NR node B (gNB)) detects the preamble, it estimates the timing advance (TA) the UE should use in order to obtain UL synchronization at the BS (e.g. gNB). The “RA preamble transmission” by the UE is also called as Message #1 (Msg1).

At step 2, the BS (e.g. gNB) sends an RA response (RAR) including the TA, the temporary cell radio network temporary identity (TC-RNTI) to be used by the UE, a random access preamble identifier that matches the transmitted PREAMBLE_INDEX and a grant for Msg3. The UE expects the RAR and thus, monitors PDCCH addressed to RA-RNTI to receive the RAR message from the BS (e.g. gNB) until the configured RAR window (ra-ResponseWindow) has expired or until the RAR has been successfully received.

At step 3, in Message #3 (Msg3) the UE transmits: its identifier (UE ID) for initial access; or if it is already in RRC_CONNECTED or RRC_INACTIVE mode and needs to e.g. re-synchronize, its UE-specific RNTI. If the BS (e.g. gNB) cannot decode Msg3 at the granted UL resources, it may send a DCI addressed to TC-RNTI for retransmission of Msg3. HARQ retransmission is requested until the UE restarts the random access procedure from step 1 after reaching the maximum number of HARQ retransmissions or until Msg3 can be successfully received by the BS (e.g. gNB). The “UE ID transmission” by the UE is also called as Message #3 (Msg3).

At step 4 (contention resolution), in Message #4 (Msg4) the BS (e.g. gNB) responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously. For Msg4 reception, the UE monitors TC-RNTI (if it transmitted its UE ID in Msg3) or C-RNTI (if it transmitted its C-RNTI in Msg3). The “UE ID transmission” by BS for contention resolution is also called as Message #4 (Msg4).

The 2-step RA type gives much shorter latency than the ordinary 4-step RA. In the 2-step RA, the RA preamble (Msg1) and a message corresponding to Msg3 (msgA PUSCH) in the 4-step RA can, depending on configuration, be transmitted in two subsequent slots. The msgA PUSCH is sent on a resource dedicated to the specific RA preamble. This means that both the preamble and the Msg3 face contention but contention resolution in this case means that either both preamble and Msg3 are sent without collision or both collide. The 2-step RA procedure is depicted in FIG. 2B. Upon successful reception of msgA, the gNB will respond with a msgB. The msgB may be either a “successRAR”, “fallbackRAR or “Back off”. The content of msgB has been agreed as shown in FIG. 2B. It is noted in particular that fallbackRAR provides a grant for a Msg3 PUSCH that identifies resources in which the UE should transmit the PUSCH, as well as other information.

If both the 4-step and 2-step RA are configured in a cell on shared PRACH resources (and for the UE), the UE will choose its preamble from one specific set if it wants to do a 4-step RA, and from another set if it wants to do a 2-step RA. Hence a preamble partition is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or 4-step procedure.

In 2-step RA type procedure, UEs are informed of the potential time-frequency resources where they may transmit MsgA PRACH and MsgA PUSCH via higher layer signaling from the network. PRACH is transmitted in periodically recurring random access channel (RACH) occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions which is measured from the start of a corresponding RACH occasion. Multiple PUSCH occasions may be multiplexed in time and frequency in a MsgA PUSCH configuration, where POs in an orthogonal frequency division multiplexing (OFDM) symbol occupy a given number of physical resource blocks (PRBs) and are adjacent in frequency, and where POs occupy ‘L’ contiguous OFDM symbols. POs multiplexed in time in a MsgA PUSCH configuration may be separated by a configured gap ‘G’ symbols long. The start of the first occupied OFDM symbol in a PUSCH slot is indicated via a start and length indicator value (‘SLIV’). The MsgA PUSCH configuration may comprise multiple contiguous PUSCH slots, each slot containing the same number of POs. The start of the first PRB relative to the first PRB in a bandwidth part (BWP) is also given by the MsgA PUSCH configuration. Moreover the modulation and coding scheme (MCS) for MsgA PUSCH is also given by the MsgA PUSCH configuration.

Each PRACH preamble maps to a PUSCH occasion and a DMRS port and/or a DMRS port-scrambling sequence combination according to a procedure given in the 3GPP technical specification (TS) 38.213 v17.0.0. This mapping allows a BS (e.g. gNB) to uniquely determine the location of the associated PUSCH in time and frequency as well as the DMRS port and/or scrambling from the preamble selected by the UE.

The PRACH preambles also map to associated SSBs. The SSB to preamble association combined with the preamble to PUSCH association allow a PO to be associated with a RACH preamble. This indirect preamble to PUSCH mapping may be used to allow a gNB using analog beamforming to receive a MsgA PUSCH with the same beam that it uses to receive the MsgA RACH preamble.

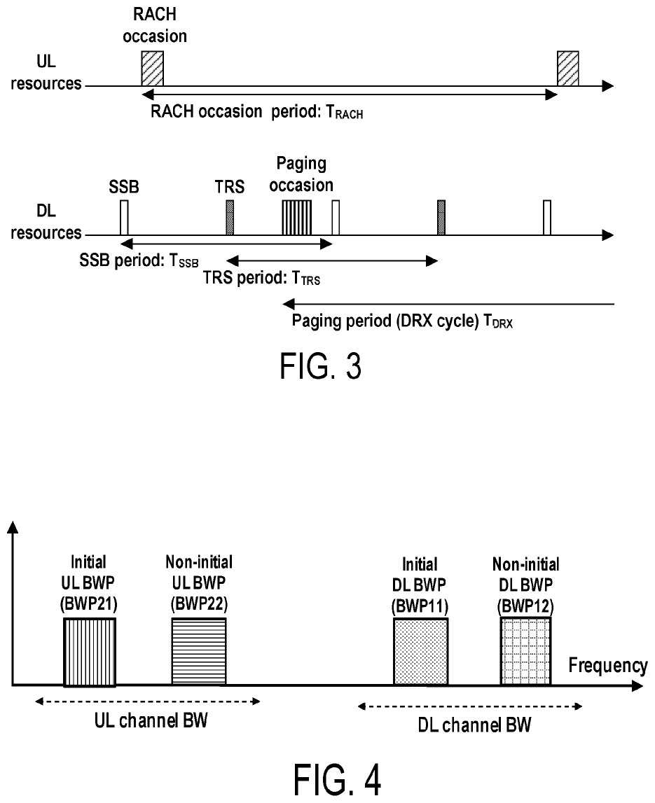

In NR, since BS (e.g. gNB) controls the UL transmission to avoid the collision among UEs, the BS (e.g. gNB) assigns the dedicated UL resources in frequency and time domain. One exception is the case when UE will make an initial access to gNB from IDLE/INACTIVE states. Random access is the procedure used when the UE initiates a connection with the BS (e.g. gNB). In both 4-step RA type and 2-step RA type procedures, the UE transmits random access preamble using PRACH at the beginning of random access attempts. Since BS (e.g. gNB) does not know when the UE initiates the random access, the BS (e.g. gNB) allocates the UL resources for PRACH periodically, called RACH periodicity. RACH periodicity is configurable, e.g., 10 ms. 20 ms, 40 ms, 80 ms, and 160 ms. FIG. 3 illustrates the relation between RACH occasion and paging period (or discontinuous reception (DRX) cycle).

In one scenario, the Redcap UE can be configured with CD-SSB in initial BWP while no SSB in non-initial BWP. In another scenario, the Redcap UE can be configured with CD-SSB in the initial BWP while NCD-SSB in the non-initial BWP. In some scenario, the UE may be configured to perform measurements on CD-SSB but the UE may be expected to perform one or more procedures (e.g. RACH transmission) in the non-initial BWP which does not contain NCD-SSB. The transmission timing of the uplink signals is derived based on DL transmission timing. Therefore, the UE may be required to track downlink timing before performing transmission of signals e.g. RACH. The UE behavior for transmission of signals in the non-initial BWP is unclear since the UE may be performing measurements on CD-SSB in the initial BWP.

The present disclosure proposes a new efficient procedure for transmission of UL signals in the non-initial BWP. According to the basic idea, a UE configured with a first DL BWP (BWP11), is further to transmit an uplink signal (e.g. RACH) within a bandwidth of a second UL BWP (BWP22), which is associated with a second DL BWP (BWP12). The UE determines whether BWP11 and BWP12 meet a BWP similarity condition, and performs one or more operational tasks related to or involving UL transmission based on whether BWP11 and BWP12 meet the similarity condition.

In one exemplary scenario, bandwidth (BW) of BWP11 contains a first RS (RS1) and BW of BWP12 contains a second RS (RS2). In another exemplary scenario, BW of BWP11 contains RS1 but BW of BWP12 does not contain RS2. BWP11 may further be associated with a first UL BWP (BWP21). The UE may further be configured to perform a radio operation involving RS1, e.g. measurement on RS1, timing and/or frequency tracking on RS1, etc.

The BWP similarity condition defines similarity in terms of radio properties or characteristics associated with the frequencies of at least two BWPs (e.g. BWP11 and BWP12) or signals (e.g. RSs) transmitted within the BW of the at least two BWPs (e.g. RS1 and RS2). For example, BWP11 and BWP12 meet the BWP similarity condition, if the magnitude of the difference between the frequencies (e.g. center frequencies) of BWP11 and BWP12 are within certain margin (e.g. 20 MHz), or the magnitude of the difference between the frequencies (e.g. center frequencies) of RS1 and RS2 are within certain margin (e.g. 20 MHz). In another example, BWP11 and BWP12 meet the BWP similarity condition provided that both RS1 and RS2 are transmitted within their respective BWPs (BWP11 and BWP12). In another example, BWP11 and BWP12 meet the BWP similarity condition provided that the magnitude of the difference of transmission powers of RS1 and RS2 is within certain threshold and/or known to the UE.

In one exemplary example, BWP11 and BWP21 are initial DL BWP, and initial UL BWP respectively. BWP12 and BWP22 are non-initial DL BWP, and non-initial UL BWP respectively. BWP12 and BWP22 may also be Redcap specific DL BWP and Redcap specific UL BWP respectively. RS1 and RS2 are CD-SSB and NCD-SSB respectively. UL signal to be transmitted within BW of BWP22 is RACH, e.g. Msg1 of RACH, etc.

Some examples of the operational tasks are provided as follows. In one example, if BWP11 and BWP12 meet the BWP similarity condition, then the UE performs a radio operational task (e.g. cell change such as handover (HO)) involving the UL signal (e.g. RACH) transmission within the BW of BWP22. The UE may further perform the radio operational task (e.g. cell change) within a time period (Tx) which is shorter than another time period (Ty), where Ty is the time period over which the UE can perform the same radio operational task when BWP11 and BWP12 do not meet the BWP similarity condition.

In another example, if BWP11 and BWP12 do not meet the BWP similarity condition, then the UE does not perform a radio operational task (e.g. cell change such as HO) involving the UL signal transmission within the BW of BWP22, or the UE does not transmit the UL signal transmission within the BW of BWP22.

In another example, the UE may decide not to transmit the UL signal (e.g. RACH) within the BW of BWP22 provided that the following BWP similarity condition is met: if the magnitude of the difference between the frequencies (e.g. center frequencies) of BWP11 and BWP12 is not within certain margin (e.g. 20 MHz); and RS2 is not transmitted within the BW of BWP12.

In another exemplary example, BWP11 and BWP21 are initial DL BWP, and initial UL BWP respectively. BWP12 and BWP22 are non-initial DL BWP, and non-initial UL BWP respectively. BWP12 and BWP22 may also be Redcap specific DL BWP and Redcap specific UL BWP respectively. RS1 and RS2 are CD-SSB and NCD-SSB respectively. NW configures the measurement with both CD-SSB and NCD-SSB frequency.

Some examples of the operational tasks are provided as follows. In one example, if BWP11 and BWP12 meet the BWP similarity condition, then the UE is configured with a radio operational task (e.g. RSRP measurement such as neighbor cell measurement) for RS1 and RS2. The UE may further perform the radio operational task (e.g. RSRP measurement such as neighbor cell measurement) for RS2 within a time period (Tx) and does not perform the radio operational task (e.g. RSRP measurement such as neighbor cell measurement) for RS1 within a time period (Ty) provided that the following BWP similarity condition is met: if the magnitude of the difference between the frequencies (e.g. center frequencies) of BWP11 and BWP12 is within certain margin (e.g. 20 MHz), and if the magnitude of the difference between the powers of RS1 and RS2 is within certain margin (e.g. 3 dB); and if the periodicity between RS1 and RS2 is the same; and RS2 is received within the BW of BWP22. Ty is the time period over which the UE can perform the same radio operational task when BWP11 and BWP12 do not meet the BWP similarity condition.

In another example, if BWP11 and BWP12 do not meet the BWP similarity condition, then the UE performs both radio operational tasks (e.g. RSRP measurement such as neighbor cell measurement) for RS1 and RS2.

The solution of the present disclosure may be applicable to a communication system including a terminal device and a network node (e.g. a base station). The terminal device can communicate through a radio access communication link with the base station. The base station can provide radio access communication links to terminal devices that are within its communication service cell. Note that the communications may be performed between the terminal device and the base station according to any suitable communication standards and protocols.

Examples of the network node include Node B, base station (BS), multi-standard radio (MSR) radio node such as MSR BS, evolved Node B (eNodeB), next generation Node B (gNodeB), master eNodeB (MeNB), secondary eNodeB (SeNB), location measurement unit (LMU), integrated access backhaul (IAB) node, network controller, radio network controller (RNC), base station controller (BSC), relay, donor node controlling relay, base transceiver station (BTS), central unit (e.g. in a gNB), distributed unit (e.g. in a gNB), baseband unit, centralized baseband, cloud RAN (C-RAN), access point (AP), transmission points, transmission nodes, transmission reception point (TRP), remote radio unit (RRU), remote radio head (RRH), nodes in distributed antenna system (DAS), core network node (e.g. mobile switching center (MSC), mobility management entity (MME), etc.), O&M, operation support system (OSS), self-organization network (SON), positioning node (e.g. evolved serving mobile location center (E-SMLC)), etc.

The terminal device may also be referred to as, for example, device, access terminal, user equipment (UE), mobile station, mobile unit, subscriber station, or the like. The non-limiting term UE (or terminal device) may refer to any type of wireless device communicating with a network node and/or with another UE in a cellular or mobile communication system. Examples of UE include target device, device to device (D2D) UE, vehicular to vehicular (V2V), machine type UE, machine type communication (MTC) UE or UE capable of machine to machine (M2M) communication, personal digital assistant (PDA), tablet, mobile terminals, smart phone, laptop embedded equipment (LEE), laptop mounted equipment (LME), universal serial bus (USB) dongles, etc.

The term radio access technology, or RAT, may refer to any RAT e.g. universal terrestrial radio access (UTRA), evolved-UMTS terrestrial radio access (E-UTRA), narrow band Internet of things (NB-IoT), WiFi, Bluetooth, next generation RAT, New Radio (NR), 4G, 5th generation (5G), etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block, discovery reference signal (DRS), CRS, PRS etc. RS may be periodic e.g. RS occasion carrying one or more RSs may occur with certain periodicity e.g. 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN), etc. Therefore, SMTC occasion may also occur with certain periodicity e.g. 5 ms, 10 ms, 20 ms, 40 ms, 80 ms and 160 ms. Examples of UL physical signals include reference signal such as SRS, DMRS etc. The term physical channel may refer to any channel carrying higher layer information e.g. data, control, etc. Examples of physical channels include PBCH, narrow band PBCH (NPBCH), physical downlink control channel (PDCCH), physical downlink shared channel (PDSCH), short physical uplink control channel (sPUCCH), short PDSCH (sPDSCH), sPUCCH, short physical uplink shared channel (sPUSCH), MTC physical downlink control channel (MPDCCH), narrow band PDCCH (NPDCCH), narrow band PDSCH (NPDSCH), enhanced PDCCH (E-PDCCH), PUSCH, PUCCH, narrow band PUSCH (NPUSCH), etc.

A term raster may be used herein. To simplify the initial cell search procedure in the UE, the synchronization channel (i.e. SSB) in the base station can be configured only at predefined locations in the frequency domain called as synchronization raster. This enables UE to tune its local oscillator only at one of the raster points at a time assuming it to be the frequency of the SSB being searched. The number of hypotheses used for the initial cell search therefore depends on the raster granularity or resolution, i.e. frequency separation between any two successive raster points.

The term time resource used herein may correspond to any type of physical resource or radio resource expressed in terms of length of time. Examples of time resources include: symbol, time slot, subframe, radio frame, transmission time interval (TTI), interleaving time, slot, sub-slot, mini-slot, system frame number (SFN) cycle, hyper-SFN (H-SFN) cycle, etc.

Now, some embodiments will be described below to explain the solution of the present disclosure.

### Scenario Description and Common Aspects

The scenario comprises a UE served by a first cell (cell1), which is served or managed by a network node (NW1). Cell1 belongs to or operates on a first carrier frequency (F1). The UE is further configured with a first DL BWP (BWP11) and a second DL BWP (BWP12) within the cell bandwidth e.g. within DL BW of cell1. The UE may further be configured with the corresponding first UL BWP (BWP21) and a second UL BWP (BWP22) within the cell bandwidth e.g. within UL BW of cell1. A DL BWP is associated with a corresponding UL BWP e.g. for UL transmission in UL BWP. The UE may perform DL operation (e.g. time and/or frequency tracking) on DL signals (e.g. RS) within DL BWP. For example, BWP11 is associated with BWP21, and BWP12 is associated with BWP22. In one example, BWP11 and BWP12 are initial DL BWP and non-initial DL BWP respectively, and BWP21 and BWP22 are initial UL BWP and non-initial UL BWP respectively. BWP12 and BWP22 may also be configured as Redcap DL BWP (or Redcap specific DL BWP) and Redcap UL BWP (or Redcap specific UL BWP) respectively. One example of BWP11, BWP12, BWP21 and BWP22 configured in an FDD cell is shown in FIG. 4.

In some embodiments, the UE may be configured to transmit an uplink signal within the BW of BWP22 in cell1. In some embodiments, the UE may be configured to transmit an uplink signal within the BW of BWP22 in a second cell (cell2). Cell2 may be a target cell e.g. for performing cell change from cell1 to cell2. Cell2 may belong or operate on a first carrier frequency F1 or on a second carrier frequency (F2). Cell2 may be served by NW1 or by a second network node (NW2). Examples of UL signals are RACH (e.g. 2-step RA, 4-step RA, etc.), UL channel (e.g. PUCCH, PUSCH), UL physical signal (e.g. SRS). The UE may be configured to transmit the uplink signal as part of certain procedure e.g. acquisition of timing advance at the base station in cell1 or cell2, RACH transmission during cell change in cell1, etc. Examples of cell change procedure are cell reselection, handover, RRC connection release with redirection, RRC connection re-establishment, etc.

In some embodiments, the UE is configured with a first reference signal (RS1), whose bandwidth is within the bandwidth of BWP11 but may not be configured with DL RS in BWP12. In some embodiments, the UE is configured with RS1, whose bandwidth is within the bandwidth of BWP11 and is also configured with a second reference signal (RS2), whose bandwidth is within the bandwidth of BWP12. Specific examples of RS1 and RS2 are CD-SSB and NCD-SSB respectively.

Examples of relation or differences between RS1 and RS2 are provided as follows. Firstly, the frequencies over which RS1 and RS2 are transmitted are not identical. In one example, the center frequencies of RS1 and RS2 are different. In another example, the starting points of frequencies (in frequency domain) of RS1 and RS2 are different. In another example, the ending points of frequencies (in frequency domain) of RS1 and RS2 are different. The magnitude of any of the above differences in frequency domain may be larger than the magnitude of the frequency error e.g. larger than 0.1 ppm. In another example, RS1 is transmitting on a synchronization raster while RS2 is not transmitting on a synchronization raster.

Secondly, for performing some procedures, any of the RS1 and RS2 may be used by the UE e.g. for performing signal measurements such as cell search RSRP, RSRQ etc.

Thirdly, for performing some procedures, the UE can use only RS1 and not RS2. For example, the UE can use only RS1 for performing initial cell search or cell selection.

Fourthly, for performing some procedures, the UE can use only RS2 and not RS1. For example, the UE may be explicitly configured to perform certain measurements on RS2 e.g. based on received indication from the network node or based on a pre-defined rule.

Fifthly, the RS1 and RS2 may be transmitting in partially or fully overlapping time resources in time, or they may be transmitted in non-overlapping time resources in time.

Sixthly, the UE may be configured with different BWPs (BWP1 and BWP2) associated with RS1 and RS2 respectively.

Examples of RS1 and RS2 are given as below. In one example, RS1 and RS2 are different SSBs, e.g. a first SSB (SSB1) and a second SSB (SSB2) respectively. In another example, RS1 and RS2 are CD-SSB and NCD-SSB respectively. In another example, RS1 and RS2 are CSI-RS and NCD-SSB respectively.

### Method in UE for Adapting Transmission Procedure Based on BWP Relations

According to the basic idea, the UE which is configured to transmit an uplink signal within the BW of BWP22, determines whether BWP11 and BWP12 meet a BWP similarity condition, and performs one or more operational tasks based on whether the BWP similarity condition is met.

The UE may further be configured to perform one or more operations on RS1 e.g. measurement on RS1, time and/or frequency tracking on RS1. The UE may have performed at least one operation on RS1 (e.g. time tracking on RS1, measurement on RS1, etc.) before or around the time the UE is configured to transmit an uplink signal within the BW of BWP22.

The BWP similarity condition defines or determines similarity or commonality in terms of radio properties or characteristics associated with the frequencies of at least two BWPs, e.g. BWP11 and BWP12. The above steps will be described below with examples.

### Criteria for BWP11 and BWP12 Meeting BWP Similarity Condition

The UE may evaluate whether it meets the BWP similarity condition periodically or when the UE is triggered to transmit the UL signal (e.g. RACH) within the BW of BWP22.

At least two BWPs (e.g. BWP11 and BWP12) meet the BWP similarity condition provided that at least one of the following criteria is met. Otherwise (if no criterion is met), the at least two BWPs (e.g. BWP11 and BWP12) do not meet the BWP similarity condition. Examples of criteria for meeting the BWP similarity condition are described as below.

Criterion 1 is overlapping in frequency. It is met if the BW of BWP11 and the BW of BWP12 at least partially overlap with respect to each other in frequency domain.

Criterion 2 is closeness in frequency. It is met if the BW of BWP11 and the BW of BWP12 do not even partially overlap with respect to each other in frequency domain but they are close to each other in frequency domain. BWP11 and BWP12 are considered to be close to each in frequency domain provided that at least one of the following conditions or criteria (a) to (f) are met; otherwise they are not considered to be close to each other in frequency domain.

Condition (a) is if the difference in frequency between BWP11 and BWP12 is within certain threshold (H1).

Condition (b) is if the difference in frequency between BWP11 and BWP12 is not larger than certain threshold (H2).

Condition (c) is if the magnitude of the difference between the frequency of BWP11 and the frequency of BWP12 is less than or equal to certain threshold (H3). There may be seven specific examples (I) to (VII) of this condition (c). Example (I) is if the magnitude of the difference between the end of BWP11 in frequency and the start of BWP12 in frequency is less than or equal to or within certain threshold (H31).

Example (II) is if the magnitude of the difference between the start of BWP11 in frequency and the start of BWP12 in frequency is less than or equal to or within certain threshold (H32). Example (III) is if the magnitude of the difference between the start of BWP11 in frequency and the end of BWP12 in frequency is less than or equal to or within certain threshold (H33). Example (IV) is if the magnitude of the difference between the end of BWP12 in frequency and the start of BWP11 in frequency is less than or equal to or within certain threshold (H34). Example (V) is if the magnitude of the difference between the start of BWP12 in frequency and the start of BWP11 in frequency is less than or equal to or within certain threshold (H35). Example (VI) is if the magnitude of the difference between the start of BWP12 in frequency and the end of BWP11 in frequency is less than or equal to or within certain threshold (H36). Example (VII) is if the magnitude of the difference between the center frequency of BWP11 and the center frequency of BWP12 is less than or equal to or within certain threshold (H37).

Condition (d) is if the distance in frequency between frequencies of RS1 and RS2 is within certain threshold (H4). Condition (e) is if the distance in frequency between RS1 and RS2 is not larger than certain threshold (H5).

Condition (f) is if the magnitude of the difference between the frequency of RS1 and the frequency of RS2 is less than or equal to certain threshold (H6). There may be seven specific examples (I) to (VII) of this condition (f). Example (I) is if the magnitude of the difference between the end of RS1 in frequency and the start of RS2 in frequency is less than or equal to or within certain threshold (H61). Example (II) is if the magnitude of the difference between the start of RS1 in frequency and the start of RS2 in frequency is less than or equal to or within certain threshold (H62). Example (III) is if the magnitude of the difference between the start of RS1 in frequency and the end of RS2 in frequency is less than or equal to or within certain threshold (H63). Example (IV) is if the magnitude of the difference between the end of RS2 in frequency and the start of RS1 in frequency is less than or equal to or within certain threshold (H64). Example (V) is if the magnitude of the difference between the start of RS2 in frequency and the start of RS1 in frequency is less than or equal to or within certain threshold (H65). Example (VI) is if the magnitude of the difference between the start of RS2 in frequency and the end of RS1 in frequency is less than or equal to or within certain threshold (H66). Example (VII) is if the magnitude of the difference between the center frequency of RS1 and the center frequency of RS2 is less than or equal to or within certain threshold (H67).

Criterion 3 is transmission power relation. It is met if the transmit power (P11) of at least one signal (e.g. RS1) transmitted within the BW of BWP11 and the transmit power (P12) of at least one signal (e.g. RS2) transmitted within the BW of BWP12 are related to each other according to at least one of the following rules:
(a) If the magnitude of power difference (ΔP) between P₁₁ and P₁₂ is within certain threshold (G1) (e.g. power offset parameter). In one example G1=0 dB.
(b) The magnitude of difference between P₁₁ and P₁₂ is known to the UE. Then the UE can adjust its receiver based on the known difference. In this case, the magnitude of AP may or may not be within G1. The UE may acquire based on a rule, which may be pre-defined or configured by the network node e.g. acquiring G1 via higher layer signaling.

Criterion 4 is timing relation. It is met if the transmission periodicity (T_{RS1}) of RS1 transmitted within the BW of BWP11 and the transmission periodicity (T_{RS2}) of RS2 transmitted within the BW of BWP12 are related to each other according to at least one of the following rules:
(a) If T_{RS1} and T_{RS2} are the same e.g. both are 40 ms. Specific examples of T_{RS1} are CD-SSB periodicity, SMTC periodicity for SMTC containing CD-SSB, etc. Specific examples of T_{RS2} are NCD-SSB periodicity, SMTC periodicity for SMTC containing NCD-SSB etc.
(b) If the magnitude of the difference between T_{RS1} and T_{RS2} is less than or equal to certain threshold (G2). In one example, G2=0. In another example, G2=40 ms.

Criterion 5 is measurement gap relation (DL). If the UE performs measurements on RS1 and RS2, the UE shall perform the measurement according to the following rules provided that the combination of rule 1, 2, 3, 4 will be fulfiled:
(a) When both RS1 and RS2 serving cell measurements are configured, the UE should perform the serving cell measurements based on RS within the active BWP.
(b) When both RS1 and RS2 neighbour cell measurements are configured, UE should perform neighbour cell measurements based on RS without measurement gaps.
(c) When both RS1 and RS2 neighbour cell measurements are configured, UE should perform neighbour cell measurements based on any of RS if the UE performs measurements on RS1 and RS2 both with measurement gaps.

Criterion 6 is transmission of RS1 and RS2. It is met if RS1 (e.g. CD-SSB) is transmitted within the BW of BWP11 and RS2 (e.g. NCD-SSB) is transmitted within the BW of BWP12.

The thresholds H1, H2, H3, H31, H32, H33, H34, H35, H36, H37, H4, H5, H6, H61, H62, H63, H64, H65, H66, H67, G1 and G2 may be pre-defined or configured by the network node. In one example, one or more thresholds may be the same regardless of the frequency range (RF) of the operation, e.g. frequencies of the UL/DL BWPs, RS1, RS2, bandwidth etc. In another example, one or more thresholds may be different for different frequency ranges of the operation. Examples of FR are frequency range 1 (FR1), frequency range 2 (FR2), etc. Frequencies in FR1 are lower than those in FR2. In one example, FR1 comprises frequencies between 410 MHz to 7125 MHz, and FR2 comprises frequencies between 24 GHz to 71 GHz. Examples of thresholds H1, H2, H3, H31, H32, H33, H34, H35, H36, H37, H61, H62, H63, H64, H65, H66, H67 are 20 MHz, or 20 MHz in FR1 and 100 MHz in FR2 for UE configured BW, UE specific carrier BW, maximum BW supported by the UE (e.g. Redcap UE max BW, for example 20 MHz for FR1 and 100 MHz for FR2), etc. The UE may be configured with certain BW (e.g. UE specific carrier BW) by the network node e.g. via RRC signaling.

### UE Performing UL Operational Tasks Based Whether Similarity Condition is Met

If BWP11 and BWP12 meet the BWP similarity condition, then the UE performs at least one operational task belonging to a first set of operational tasks. If the BWP11 and BWP12 do not meet the BWP similarity condition, then the UE performs at least one operational task belonging to a second set of operational tasks. The UE obtains the first set and/or the second set of operational tasks based on one or more rules, which can be pre-defined or configured by a network node e.g. NW1. The first and the second set of operational tasks are described below with examples.

Examples of First Set of Operational Tasks when Meeting BWP Similarity Condition

In one example, the UE transmits the uplink signal within the BW of BWP22 without acquiring or receiving or measuring on RS2. This is because the UE may use the timing of RS1 for performing UL transmission of the signal within the BW of BWP22. This can reduce UE power consumption since the UE can avoid unnecessary measurements. The time to perform certain procedure (e.g. handover) can also be reduced.

In another example, the UE transmits the uplink signal within the BW of BWP22 within certain time period (T11) starting from a triggering time instance (Tg). Tg is the time when the UE is triggered to transmit the UL signal e.g. RACH transmission. T11 is shorter than another time period (T21). The UE can transmit the same UL signal within T21 if the BWP similarity condition is not met.

In another example, the UE performs certain procedure (e.g. cell change to cell2) involving at least the uplink signal transmission within the BW of BWP22 within certain time period (T12) starting from a time when the procedure is triggered (Tp). T12 is shorter than another time period (T22). The UE can perform the same procedure (e.g. cell change to cell2) within T22 if the BWP similarity condition is not met. For example, a rule can be defined that if the BWP similarity condition is met then the UE performs the cell change over shorter period of time compared to the case when the BWP similarity condition is not met.

In another example, the UE performs certain procedure (e.g. cell change to cell2) where at least the uplink signal transmission within the BW of BWP22 is performed within certain time period (T13), which is shorter than T23. The UE can perform the UL transmission within T23 for the same procedure (e.g. cell change to cell2) if the BWP similarity condition is not met.

In another example, at least one component (or sub-procedure) of certain procedure (e.g. cell change such as HO) is performed within certain time period (T14), which is shorter than another time period (T24). The UE can perform the same component (or the sub-procedure) of the same procedure (e.g. cell change such as HO to cell2) within T24 if the BWP similarity condition is not met. Examples of the component (or the sub-procedure) of the procedure (e.g. cell change to cell2) are cell search, fine time tracking, acquiring timing, performing automatic gain control (AGC), etc.

In another example, the UE may use any of RS1 and RS2 for acquiring timing which the UE may use for transmitting an uplink signal within the bandwidth of BWP22. The UE uses DL timing of a DL reference signal for determining transmit timing for transmitting the uplink signal. The UE also meets one or more requirements associated with the timing of the UL transmitted signal. Examples of meeting requirements are initial transmit timing error (Te) is within certain margin (e.g. ±768 Tc for subcarrier spacing (SCS)=15 KHz; 1 Tc≈0.5 ns), maximum amount of the magnitude of the timing change in one adjustment corresponds to pre-defined value (e.g. 352 Tc for SCS=15 KHz), etc. Since RS1 and RS2 have similar radio properties therefore the UE can use any of the RS1 and RS2 for determining the UL timing for transmitting the UL signal.

In another example, the UE transmits an uplink signal within the bandwidth of BWP22 even if RS2 is not transmitted or is not available at the UE. The UE further meets one or more requirements associated with the timing of the UL transmitted signal.

In another example, the UE may use RS1 for acquiring timing which the UE may further use for transmitting an uplink signal within the bandwidth of BWP22 even if RS2 is not transmitted or is not available at the UE. The UE further meets one or more requirements associated with the timing of the UL transmitted signal.

Examples of Second Set of Operational Tasks when not Meeting BWP Similarity Condition

In one example, the UE does not transmit the uplink signal. The can prevent the UE from transmitting UL signals (e.g. RACH), which the base station may not be able to receive. This in turn can also reduce the interference and UE power consumption. In one specific example, the UE does not transmit the uplink signal within the BW of BWP22. Not transmitting the UL signal may also be termed as UE discarding or abandoning the transmission of the UL signal. In one specific example, the UE may perform this operational task if RS1 is transmitted within the BW of BWP11 but RS2 is not transmitted within the BW of BWP12. In another specific example, the UE may perform this operational task if RS1 is transmitted within the BW of BWP11 but RS2 is not transmitted within the BW of BWP12, and frequencies of BWP11 and BWP12 are separated or differ by more than certain margin (e.g. 20 MHz, UE configured carrier BW, etc.). In another specific example, this operational task may be applied when the UL signals is RACH. This is because the UE after transmitting MSG1 (e.g. PRACH preamble) for 4-step RA or MSGA for 2-step RA may not be able to receive or correctly receive Msg2 (e.g. RAR) for 4-step RA or MsgB for 2-step RA from the network node e.g. due to incorrect or lack of AGC setting of the UE receiver. The UE may not be able to acquire or adjust its AGC because of the absence of RS2 in BWP12 and also due to large frequency separation between frequencies of BWP11 and BWP12.

In another example, the UE postpones or delays or defers the transmission of the uplink signal. In one specific example, the UE postpones the transmission of the uplink signal within the BW of BWP22. In one example, the UE may postpone the transmission of the uplink signal until the UE has reacquired timing of at least one DL RS e.g. RS1 and/or RS2.

In another example, the UE transmits the uplink signal within the BW of another BWP. In one example the BWP may be BWP21.

In another example, the UE transmits the uplink signal within the BW of BWP22 after acquiring or receiving or measuring on RS2. This is because the UE may not be able to use the timing of RS1 for performing UL transmission within the BW of BWP22.

In another example, the UE transmits the uplink signal within the BW of BWP22 after acquiring or receiving or measuring on RS1. This may require the UE to retune to BWP11 to acquire RS1. This may be the case when BWP12 does not contain RS2.

In another example, the UE transmits the uplink signal within the BW of BWP22 within time period (T21) starting from Tq, where T21 is longer than the time period (T11). T11 and Tq have been defined above.

In another example, the UE performs certain procedure (e.g. cell change) involving at least the uplink signal transmission within the BW of BWP22 within certain time period (T22) starting from triggering time instance, Tp, where T22 is longer than another time period (T12). T12 and Tp have been defined above.

In another example, the UE performs certain procedure (e.g. cell change) where at least the uplink signal transmission within the BW of BWP22 is performed within certain time period (T23), which is longer than T13. T13 has been defined above.

In another example, at least one component (or sub-procedure) of certain procedure (e.g. cell change such as HO) is performed within certain time period (T24), which is longer than another time period (T14). T14 has been defined above.

In another example, the UE may use RS2 for acquiring timing which the UE may further use for transmitting an uplink signal within the bandwidth of BWP22 even if RS2 is not transmitted or is not available at the UE. The UE further meets one or more requirements associated with the timing of the UL transmitted signal.

In another example, the UE refrains from transmitting an uplink signal or postpones transmitting an uplink signal within the bandwidth of BWP22 if RS2 is not transmitted or is not available at the UE.

In another example, if RS2 is not transmitted or is not available at the UE, then the UE is not required to meet one or more requirements associated with the timing of the UL signal transmitted by the UE within the bandwidth of BWP22.

### UE Performing DL Operational Tasks Based Whether Similarity Condition is Met

If BWP11 and BWP12 meet the BWP similarity condition, then the UE performs measurements on only one of RS1 and RS2 based on the Criterion 5 mentioned above. In an example, if the BWP11 and BWP12 meet the BWP similarity condition, then the UE performs measurements on RS1 based on the Criterion 5.

In another example, if the BWP11 and BWP12 meet the BWP similarity condition, then the UE performs measurements on RS2 based on the Criterion 5.

In an example, if the BWP11 and BWP12 do not meet the BWP similarity condition, then the UE performs measurements on both RS1 and RS2 based on the Criterion 5.

In another example, if the BWP11 and BWP12 do not meet the BWP similarity condition, then the UE performs measurements on at least RS1 based on the Criterion 5.

In another example, if the BWP11 and BWP12 do not meet the BWP similarity condition, then the UE performs measurements on at least RS2 based on the Criterion 5.

Examples of First Set of DL Operational Tasks when Meeting BWP Similarity Condition

In one example, the UE performs serving cell measurements within the BW of BWP12 on RS2. In another example, the UE performs serving cell measurements within the BW of BWP11 on RS1. In another example, the UE performs neighbour cell measurements within the BW of BWP12 on RS2. In another example, the UE performs neighbour cell measurements within the BW of BWP11 on RS1.

Examples of Second Set of Operational Tasks when not Meeting BWP Similarity Condition

In one example, the UE performs serving cell measurements within both the BW of BWP12 on RS2 and the BW of BWP11 on RS1. In another example, the UE performs neighbour cell measurements within both the BW of BWP12 on RS2 and the BW of BWP11 on RS1.

The UE obtains the first set and/or the second set of operational tasks based on one or more rules, which can be pre-defined or configured by a network node e.g. NW1.

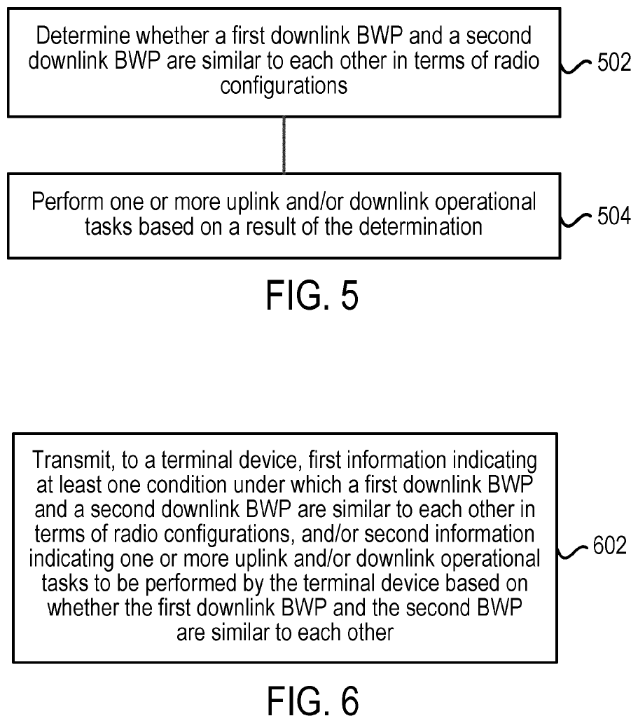

Hereinafter, the solution of the present disclosure will be further described with reference to FIGS. 5-20.

FIG. 5 is a flowchart illustrating a method performed by a terminal device according to an embodiment of the disclosure. At block 502, the terminal device determines whether a first downlink BWP and a second downlink BWP are similar to each other in terms of radio configurations. The first downlink BWP and the second downlink BWP may be BWPs related to or usable by the terminal device. As an example, the first downlink BWP may be an initial downlink BWP, and the second downlink BWP may be a non-initial downlink BWP. As another example, the first downlink BWP may be an initial downlink BWP, and the second downlink BWP may be a Redcap downlink BWP. The radio configuration of a BWP may include, but not limited to, the frequencies of the BWP, whether there is an RS contained in the BWP, the transmission power of the RS, the transmission periodicity of the RS, etc.

In a scenario, a bandwidth of the first downlink BWP may contain a first RS, and a bandwidth of the second downlink BWP may contain a second RS. As an example, each of the first RS and the second RS may be an SSB. As another example, the first RS may be a CD-SSB, and the second RS may be an NCD-SSB. As still another example, the first RS may be a CSI-RS, and the second RS may be an NCD-SSB. In another scenario, the bandwidth of the first downlink BWP may contain the first RS, and the bandwidth of the second downlink BWP may contain no RS.

Block 502 may be performed periodically or in response to a trigger. For example, the first downlink BWP and the second downlink BWP may be determined to be similar to each other when at least one of following conditions is satisfied: a bandwidth of the first downlink BWP and a bandwidth of the second downlink BWP at least partially overlap with each other in frequency domain; the bandwidth of the first downlink BWP and the bandwidth of the second downlink BWP are close to each other in frequency domain; a first RS is transmitted within the bandwidth of the first downlink BWP and a second RS is transmitted within the bandwidth of the second downlink BWP; a difference between transmission powers of the first RS and the second RS is within a predetermined threshold power; the difference between transmission powers of the first RS and the second RS is known to the terminal device; a transmission periodicity of the first RS and a transmission periodicity of the second RS are the same; and a difference between the transmission periodicities of the first RS and the second RS is less than or equal to a predetermined threshold time. On the other hand, if one or more of the above conditions are not satisfied, the first downlink BWP and the second downlink BWP may be determined to be not similar to each other.

For example, the bandwidth of the first downlink BWP and the bandwidth of the second downlink BWP may be determined to be close to each other in frequency domain, when at least one of following conditions is satisfied: a difference in frequency between the first downlink BWP and the second downlink BWP is within a first predetermined threshold; the difference in frequency between the first downlink BWP and the second downlink BWP is not larger than a second predetermined threshold; a difference between a frequency related to the first downlink BWP and a frequency related to the second downlink BWP is less than or equal to a third predetermined threshold; a distance in frequency between the first RS and the second RS is within a fourth predetermined threshold; the distance in frequency between the first RS and the second RS is not larger than a fifth predetermined threshold; and a difference between a frequency related to the first RS and a frequency related to the second RS is less than or equal to a sixth predetermined threshold.

For example, the frequency related to the first downlink BWP may be a start/end/center frequency of the first downlink BWP, and the frequency related to the second downlink BWP may be a start/end/center frequency of the second downlink BWP. The frequency related to the first RS may be a start/end/center frequency of the first RS, and the frequency related to the second RS may be a start/end/center frequency of the second RS. Note that each of the predetermined threshold power, the predetermined threshold time, and the first to sixth predetermined thresholds may be configured by a network node or predefined in the terminal device.

At block 504, the terminal device performs one or more uplink and/or downlink operational tasks based on a result of the determination. With the method of FIG. 5, it is possible to improve the performance of the terminal device in the case of multiple BWPs since the similarity between the multiple BWPs is considered. The one or more uplink operational tasks may be performed within a bandwidth of a second uplink BWP associated with the second downlink BWP, or a first uplink BWP associated with the first downlink BWP, based on the result of the determination. As an example, the first uplink BWP may be an initial uplink BWP, and the second uplink BWP may be a non-initial uplink BWP. As another example, the first uplink BWP may be an initial uplink BWP, and the second uplink BWP may be a Redcap uplink BWP. The one or more downlink operational tasks may be performed within a bandwidth of the first downlink BWP and/or the second downlink BWP, based on the result of the determination.

For example, a first set of uplink operational tasks may be performed when determining that the first downlink BWP and the second downlink BWP are similar to each other. The first set of uplink operational tasks may comprise, but not limited to, at least one of: transmitting an uplink signal within the bandwidth of the second uplink BWP without measuring a second RS contained in a bandwidth of the second downlink BWP; transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other; performing a component of a second predetermined procedure (e.g. a handover procedure) within a third time period, wherein the third time period is shorter than a fourth time period within which the same component of the same second predetermined procedure is performed in a case where the first downlink BWP and the second downlink BWP are not similar to each other; using one of the first RS and the second RS for acquiring timing for transmitting an uplink signal within the bandwidth of the second uplink BWP; using the first RS for acquire timing for transmitting an uplink signal within the bandwidth of the second uplink BWP if the second downlink BWP does not contain the second RS; and transmitting an uplink signal within the bandwidth of the second uplink BWP even if the second downlink BWP does not contain the second RS.

For example, a second set of uplink operational tasks may be performed when determining that the first downlink BWP and the second downlink BWP are not similar to each other. The second set of uplink operational tasks may comprise, but not limited to, at least one of discarding a transmission of an uplink signal within the bandwidth of the second uplink BWP; postponing a transmission of an uplink signal within the bandwidth of the second uplink BWP; transmitting an uplink signal within a bandwidth of a different uplink BWP (e.g. the first uplink BWP) than the second uplink BWP; transmitting an uplink signal within the bandwidth of the second uplink BWP after measuring a second RS contained in a bandwidth of the second downlink BWP or a first RS contained in a bandwidth of the first downlink BWP; transmitting an uplink signal or performing a first predetermined procedure containing the transmission of the uplink signal, within the bandwidth of the second uplink BWP within a second time period, wherein the second time period is longer than a first time period within which the same uplink signal is transmitted or the same first predetermined procedure is performed in a case where the first downlink BWP and the second downlink BWP are similar to each other; performing a component of a second predetermined procedure (e.g. a handover procedure) within a fourth time period, wherein the fourth time period is longer than a third time period within which the same component of the same second predetermined procedure is performed in a case where the first downlink BWP and the second downlink BWP are similar to each other; using the second RS for acquiring timing for transmitting an uplink signal within the bandwidth of the second uplink BWP; and discarding or postponing a transmission of an uplink signal within the bandwidth of the second uplink BWP if the second downlink BWP does not contain the second RS.

For example, a first set of downlink operational tasks may be performed when determining that the first downlink BWP and the second downlink BWP are similar to each other. The first set of downlink operational tasks may comprise, but not limited to, at least one of performing serving cell measurements based on one of the first RS and the second RS which is within an active BWP, when serving cell measurements on the first RS and the second RS are configured to the terminal device; performing neighbor cell measurements based on one of the first RS and the second RS which does not have measurements gaps, when neighbor cell measurements on the first RS and the second RS are configured to the terminal device; and performing neighbor cell measurements based on one of the first RS and the second RS, when neighbor cell measurements on the first RS and the second RS are configured to the terminal device and both the first RS and the second RS have measurements gaps.

For example, a second set of downlink operational tasks may be performed when determining that the first downlink BWP and the second downlink BWP are not similar to each other. The second set of downlink operational tasks may comprise, but not limited to, at least one of performing serving cell measurements based on both the first RS and the second RS, when serving cell measurements on the first RS and the second RS are configured to the terminal device; and performing neighbor cell measurements based on both the first RS and the second RS, when neighbor cell measurements on the first RS and the second RS are configured to the terminal device. Note that the one or more uplink or downlink operational tasks may be configured by a network node or predefined in the terminal device.

FIG. 6 is a flowchart illustrating a method performed by a network node according to an embodiment of the disclosure. At block 602, the network node transmits, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other. With the method of FIG. 6, it is possible to allow the performance of the terminal device to be improved in the case of multiple BWPs. The first downlink BWP and the second downlink BWP may be BWPs related to or usable by the terminal device. As an example, the first downlink BWP may be an initial downlink BWP, and the second downlink BWP may be a non-initial downlink BWP. As another example, the first downlink BWP may be an initial downlink BWP, and the second downlink BWP may be a Redcap downlink BWP. The radio configuration of a BWP may include, but not limited to, the frequencies of the BWP, whether there is an RS contained in the BWP, the transmission power of the RS, the transmission periodicity of the RS, etc.

In a scenario, a bandwidth of the first downlink BWP may contain a first RS, and a bandwidth of the second downlink BWP may contain a second RS. As an example, each of the first RS and the second RS may be an SSB. As another example, the first RS may be a CD-SSB, and the second RS may be an NCD-SSB. As still another example, the first RS may be a CSI-RS, and the second RS may be an NCD-SSB. In another scenario, the bandwidth of the first downlink BWP may contain the first RS, and the bandwidth of the second downlink BWP may contain no RS.

For example, the at least one condition indicated by the first information may comprise, but not limited to, one or more of: a bandwidth of the first downlink BWP and a bandwidth of the second downlink BWP at least partially overlap with each other in frequency domain; the bandwidth of the first downlink BWP and the bandwidth of the second downlink BWP are close to each other in frequency domain; a first RS is transmitted within the bandwidth of the first downlink BWP and a second RS is transmitted within the bandwidth of the second downlink BWP; a difference between transmission powers of the first RS and the second RS is within a predetermined threshold power; the difference between transmission powers of the first RS and the second RS is known to the terminal device; a transmission periodicity of the first RS and a transmission periodicity of the second RS are the same; and a difference between the transmission periodicities of the first RS and the second RS is less than or equal to a predetermined threshold time. For example, the bandwidth of the first downlink BWP and the bandwidth of the second downlink BWP may be close to each other in frequency domain, when at least one of following conditions is satisfied: a difference in frequency between the first downlink BWP and the second downlink BWP is within a first predetermined threshold; the difference in frequency between the first downlink BWP and the second downlink BWP is not larger than a second predetermined threshold; a difference between a frequency related to the first downlink BWP and a frequency related to the second downlink BWP is less than or equal to a third predetermined threshold; a distance in frequency between the first RS and the second RS is within a fourth predetermined threshold; the distance in frequency between the first RS and the second RS is not larger than a fifth predetermined threshold; and a difference between a frequency related to the first RS and a frequency related to the second RS is less than or equal to a sixth predetermined threshold.

For example, the frequency related to the first downlink BWP may be a start/end/center frequency of the first downlink BWP, and the frequency related to the second downlink BWP may be a start/end/center frequency of the second downlink BWP. The frequency related to the first RS may be a start/end/center frequency of the first RS, and the frequency related to the second RS may be a start/end/center frequency of the second RS. Each of the predetermined threshold power, the predetermined threshold time, and the first to sixth predetermined thresholds may be indicated by (e.g. included in) the first information.

For example, the one or more uplink operational tasks are to be performed within a bandwidth of a second uplink BWP associated with the second downlink BWP, or a first uplink BWP associated with the first downlink BWP. As an example, the first uplink BWP may be an initial uplink BWP, and the second uplink BWP may be a non-initial uplink BWP. As another example, the first uplink BWP may be an initial uplink BWP, and the second uplink BWP may be a Redcap uplink BWP. The one or more downlink operational tasks are to be performed within a bandwidth of the first downlink BWP and/or the second downlink BWP.

For example, the one or more uplink operational tasks to be performed when the first downlink BWP and the second downlink BWP are similar to each other, may comprise, but not limited to, at least one of: transmitting an uplink signal within the bandwidth of the second uplink BWP without measuring a second RS contained in a bandwidth of the second downlink BWP; transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other; performing a component of a second predetermined procedure (e.g. a handover procedure) within a third time period, wherein the third time period is shorter than a fourth time period within which the same component of the same second predetermined procedure is performed in a case where the first downlink BWP and the second downlink BWP are not similar to each other; using one of the first RS and the second RS for acquiring timing for transmitting an uplink signal within the bandwidth of the second uplink BWP; using the first RS for acquire timing for transmitting an uplink signal within the bandwidth of the second uplink BWP if the second downlink BWP does not contain the second RS; and transmitting an uplink signal within the bandwidth of the second uplink BWP even if the second downlink BWP does not contain the second RS.

For example, the one or more uplink operational tasks to be performed when the first downlink BWP and the second downlink BWP are not similar to each other, may comprise, but not limited to, at least one of: discarding a transmission of an uplink signal within the bandwidth of the second uplink BWP; postponing a transmission of an uplink signal within the bandwidth of the second uplink BWP; transmitting an uplink signal within a bandwidth of a different uplink BWP (e.g. the first uplink BWP) than the second uplink BWP; transmitting an uplink signal within the bandwidth of the second uplink BWP after measuring a second RS contained in a bandwidth of the second downlink BWP or a first RS contained in a bandwidth of the first downlink BWP; transmitting an uplink signal or performing a first predetermined procedure containing the transmission of the uplink signal, within the bandwidth of the second uplink BWP within a second time period, wherein the second time period is longer than a first time period within which the same uplink signal is transmitted or the same first predetermined procedure is performed in a case where the first downlink BWP and the second downlink BWP are similar to each other; performing a component of a second predetermined procedure within a fourth time period, wherein the fourth time period is longer than a third time period within which the same component of the same second predetermined procedure is performed in a case where the first downlink BWP and the second downlink BWP are similar to each other; using the second RS for acquiring timing for transmitting an uplink signal within the bandwidth of the second uplink BWP; and discarding or postponing a transmission of an uplink signal within the bandwidth of the second uplink BWP if the second downlink BWP does not contain the second RS.

For example, the one or more downlink operational tasks to be performed when the first downlink BWP and the second downlink BWP are similar to each other, may comprise, but not limited to, at least one of: performing serving cell measurements based on one of the first RS and the second RS which is within an active BWP, when serving cell measurements on the first RS and the second RS are configured to the terminal device; performing neighbor cell measurements based on one of the first RS and the second RS which does not have measurements gaps, when neighbor cell measurements on the first RS and the second RS are configured to the terminal device; and performing neighbor cell measurements based on one of the first RS and the second RS, when neighbor cell measurements on the first RS and the second RS are configured to the terminal device and both the first RS and the second RS have measurements gaps.

For example, the one or more downlink operational tasks to be performed when the first downlink BWP and the second downlink BWP are not similar to each other, may comprise, but not limited to, at least one of: performing serving cell measurements based on both the first RS and the second RS, when serving cell measurements on the first RS and the second RS are configured to the terminal device; and performing neighbor cell measurements based on both the first RS and the second RS, when neighbor cell measurements on the first RS and the second RS are configured to the terminal device.

In connection with the above description, the following analysis of UE transmit timing requirements in RedCap is provided.

### 1. Introduction

The following are the open issues related to the UE transmit timing for RedCap UE identified in the last meeting as captured in the approved WF (R4-2202670, “WF on RedCap RRM requirements”, Ericsson):

### Condition for Meeting UE Transmit Timing Requirements

Redcap UE should meet the existing Te and Tq requirements provided that the SSB is available at the UE at least once every 160 ms is agreeable:
Option 1 (E///, HW, CMCC, NOkia): SSB refers to CD-SSB or any of CS- and NCD-SSB
Option 2 (Apple, QC): SSB has to be in active BWP
Option 3 (MTK): SSB refers to both CD-SSB and NCD-SSB and SSB shall be in the active BWP.

### Whether CSI-RS/TRS can be Used for Meeting the Timing Requirements

Option 1 (Xiaomi, MTK, OPPO, Nokia, QC, vivo, Xiaomi, Apple, MTK, E///): CSI-RS/TRS is not needed to acquire the reference cell timing in Rel-17.
Option 2 (HW, CMCC):
   CSI-RS can be used for RedCap UEs to acquire the reference cell timing depending on UE capability.
   No CSI-RS based timing requirements are defined the CSI-RS in R17.

Hereinafter, we analyze the open issues related to the UE timing identified in the WF for further analysis.

### 2. Analysis of Open Issues on UE Timing Requirements

### 2.1 Applicable SSB Type for Timing Requirements

Among all the three options identified in the last meeting our understanding is that there is consensus that the UE can meet the transmit requirements based on any of the CD-SSB and NCD-SSB.

The main controversial issue is that one set of companies argue that the SSB should be within the active BWP of the UE, while another set of companies argue that the SSB does not have to be within the active BWP of the UE.

In release 15, the UE transmit timing error requirements are met by the UE provided that the SSB in the DL reference cell is available at the UE at least once every 160 ms regardless of whether the SSB is within the active BWP or not. If the SSB is outside its active BWP then the UE has to retune to acquire the timing of the SSB. For Redcap the UE the same principle should apply. One difference is that the RedCap supports maximum channel bandwidth of 20 MHz and 100 MHz in FR1 and FR2 respectively. But the BW of the BS can be larger than the RedCap UE BW. This may result in that the initial BWP and the RedCap BWP are separated by more than the RedCap UE BW. In this case the UE may have to perform extra processing. Furthermore, the AGC may be invalid or inadequate for receiving in downlink after the UE has sent in the UL for which it has to meet the timing requirements. Therefore, one compromise can be that if the RedCap BWP does not contain the NCD-SSB then the UE is required to meet the timing requirements provided that the initial BWP and the RedCap BWP are not separated in frequency by more than 20 MHz for FR1 and 100 MHz for FR2.

### 2.2 CSI-RS/TRS for Timing Requirements

Firstly, as stated in section 2.1 even if the Recap BWP does not contain NCD-SSB, the UE can still retune to acquire timing from CD-SSB. Therefore, the UE can still meet the Te requirements based on CD-SSB even if NCD-SSB is not transmitted in PCell. The UE does not need to use CSI-RS for meeting Te even if NCD-SSB is not transmitted in the Redcap BWP. Another issue is that it is up to the UE implementation to decide when to acquire the DL timing for uplink transmission. Therefore, CSI-RS/TRS will have to be transmitted periodically. Unlike SSB which comprises of fixed number of PRBs, CSI-RS is configurable. Therefore, defining certain CSI-RS pattern to meet the timing requirements will require all UE and BS to implement the same pattern for CSI-RS. It is also unrealistic to converge on agreeable CSI-RS pattern especially in Rel-17.

Based on the above agreement we can conclude that CSI-RS/TRS is not needed to acquire the reference cell timing in Rel-17.

### 2. Summary

The following are the observations and proposals based on the analysis provided in this document:

### Applicability of SSB Type for Timing Requirements:

Observation #1: Redcap UE can be configured in Redcap BWP where NCD-SSB may or may not be transmitted in the PCell.

Observation #2: NCD-SSB is feasible for Redcap UE for time-frequency tracking in the PCell.

Observation #3: Even if NCD-SSB is not transmitted in UE's active RedCap BWP, the UE can DL timing from CD-SSB by retuning to initial BWP in the PCell.

Observation #4: The maximum BW of RedCap UE is 20 MHz in FR1 and 100 MHz in FR2 but cell BW can be larger than the maximum BW of the RedCap UE.

Observation #5: If initial BWP and UE's active RedCap BWP are separated by more than certain margin (e.g. 20 MHz for FR1 and 100 MHz for FR2) then UE timing based on CD-SSB may not be reliable for uplink transmission in RedCap BWP.

Proposal #1: UE shall meet the existing Te and Tq requirements for corresponding FR and SCS defined in section 7.1 of TS 38.133 provided that:
the CD-SSB or NCD-SSB is within the UE's active BWP or
the initial BWP and the RedCap BWP are within 20 MHz for FR1 or 100 MHz for FR2 if the NCD-SSB is not within the UE's RedCap active BWP.

### CSI-RS/TRS for Timing Requirements

Observation #6: UE can meet timing requirements based on CD-SSB which is always transmitted.

Observation #7: It is up to the UE implementation to decide when to acquire DL timing for uplink transmission.

Observation #8: CSI-RS is configurable but certain periodic CSI-RS pattern defined to meet the timing requirements will require all UE and BS to implement the same CSI-RS pattern.

Observation #9: It is unrealistic to reach an agreement on periodic CSI-RS pattern for meet the timing requirements in Rel-17.

Proposal #2: CSI-RS/TRS is not needed to acquire the reference cell timing in Rel-17.

In connection with the above description, the following analysis on RedCap measurement procedure is provided.

### 1. Introduction

In this document, we discuss the CONNECTED mode measurement procedures based on the agreed WF from last meeting in R4-2202670 (“WF on RedCap RRM requirements”, Ericsson). More specifically, we discuss and provide our view on following subtopics:
Intra-frequency measurement definition
CSSF design
CGI reading
Cell detection performance
SSB based RSRP measurement performance
Time index detection performance
Measurement conditions for HD-FDD

### 2. NCD-SSB Measurement

In Rel-15, the intra-frequency measurement definition for non-RedCap UE is as follow: the definition is based on the center frequency of the SSB between serving cell and the cell to-be-measured. Furthermore, in Rel-15, only CD-SSB will be applied to perform measurement.

A measurement is defined as a SSB based intra-frequency measurement provided the centre frequency of the SSB of the serving cell indicated for measurement and the centre frequency of the SSB of the neighbour cell are the same, and the subcarrier spacing of the two SSBs are also the same.

Observation 1: In Rel-15, the intra-frequency measurement definition for non-RedCap UE is based on the center frequency of the SSB between serving cell and the cell to-be-measured.

As mentioned before, NCD-SSB based measurement has been agreed in Rel-17 for RedCap UE which has bandwidth reduced to 20 MHz in FR1 and 100 MHz in FR2. The main difference between RedCap UE and non-RedCap UE is that two types of SSBs can be the reference to define the intra-frequency measurement. Therefore, RAN4 needs to further discuss the issues related to NCD-SSB measurements as follow.
NCD-SSB neighbour cell measurement
The definition of intra-frequency measurement
Serving cell measurement with both NCD-SSB and CD-SSB configuration
Neighbour cell measurement with both NCD-SSB and CD-SSB configuration
Measurement Requirement if NCD-SSB measurement is agreed

### General Scenarios

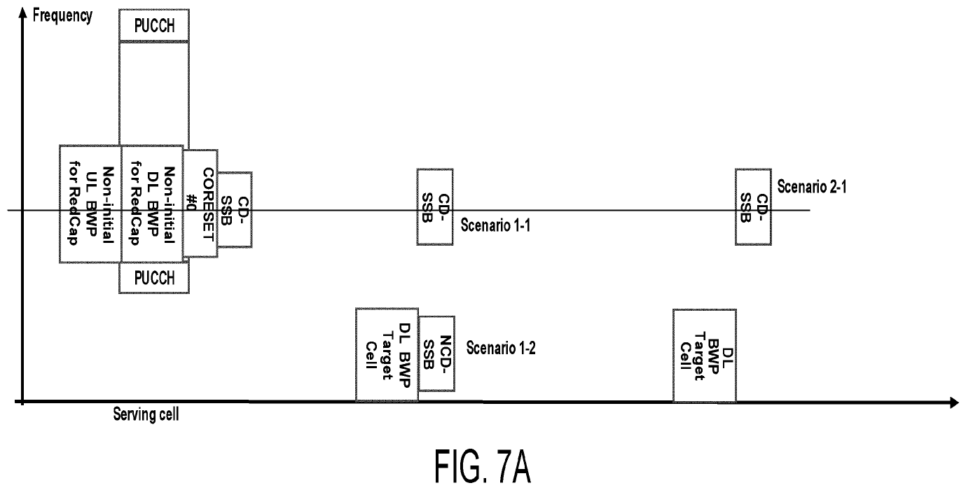

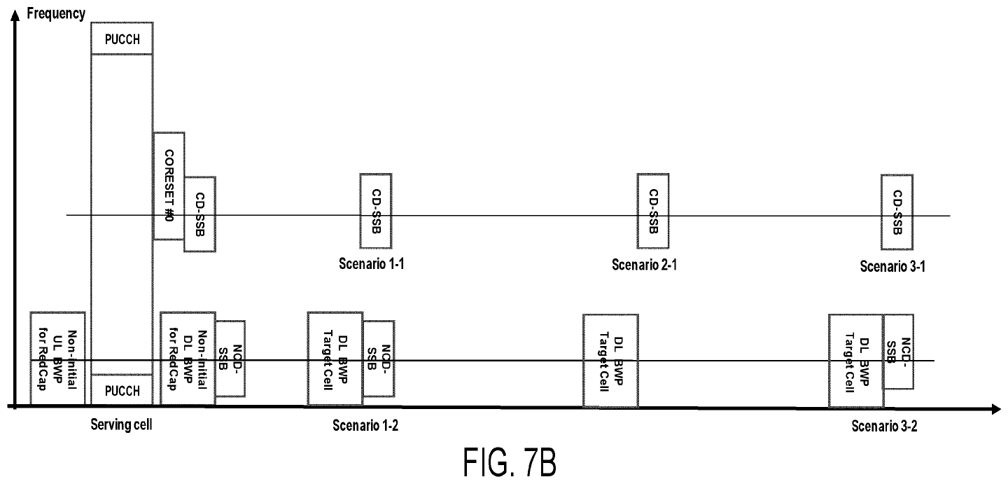

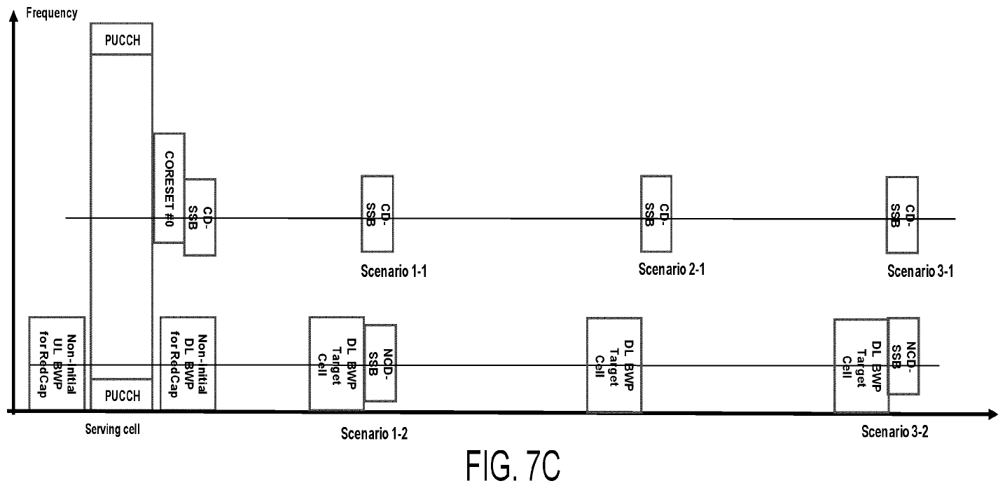

Before discussing the detail issues, the main scenarios for RedCap UEs are shown as follow.
Case A (see FIG. 7A): Serving cell active BWP with CD-SSB
Case B (see FIG. 7B): Serving cell active BWP with NCD-SSB
   Case B-1: All neighbour cells with NCD-SSB
   Case B-2: Some neighbour cells with NCD-SSB, some neighbour cells without NCD-SSB
Case C (see FIG. 7C): Serving cell active BWP without SSB

### Proposal 1: RAN4 to Discuss RedCap UE's Behaviour Based on the Following Scenarios:

Case A: Serving cell active BWP with CD-SSB
Case B: Serving cell active BWP with NCD-SSB
   Case B-1: All neighbour cells with NCD-SSB
   Case B-2: Some neighbour cells with NCD-SSB, some neighbour cells without NCD-SSB
Case C: Serving cell active BWP without SSB

### NCD-SSB Neighbour Cell Measurement

### Issue 3-1-4: RRM Measurement on Neighbour Cell in Connected Mode

Option 1: In connected mode, RRM measurement on neighbour cell is supposed to be performed on CD-SSB.

Option 2: In connected mode, RRM measurement on neighbour cell can be based on CD-SSB or NCD-SSB.

### Issue 3-1-5: If RRM Measurement on Neighbour Cell can be Based on NCD-SSB, What Assisted Information Network can Provide to UE

This issue depends on the outcome of issue 3-1-4.

FFS: The neighbor cell's NCD-SSB information (frequency/SCS) shall be provided to UE if UE is configured to perform cell identification/measurement on neighbor cell's NCD-SSB, i.e., UE is not required to read neighbor cell SIB to figure out the neighbor cell's NCD-SSB by itself.

The reason to introducing the NCD-SSB is to offload the resources for CD-SSB. Thus, the NCD-SSB has the same character as CD-SSB in most aspects. When NW configures the measurements to UE, NW will indicates the ARFCN frequency, which can be either CD-SSB or NCD-SSB (Both are possible from RAN2's signalling). Since Rel-15 the network can already request UEs to perform RRM measurements on “NCD-SSBs”. There is no new procedure for RedCap UE measuring NCD-SSB.

In last meeting, some companies argue that there is HO issue for Case B-2. However, NW shall configure the CD-SSB measurements in Case B-2 which we don't think is atypical scenario. From our understanding, it's impossible for an operator would only enable RedCap (NCD-SSB) support on a subset of the cells on a certain carrier. At the same time, Case B-1 shall be a general case since NW supports NCD-SSB transmission. Obviously, the benefits to configure NCD-SSB neighbour cell measurements other than CD-SSB measurements is that no measurement gap will be needed for NCD-SSB neighbour cell measurements. Thus, RAN4 shall define the requirement for both CD-SSB and NCD-SSB neighbour cell measurements.

Proposal 2: RAN4 to define requirement for both CD-SSB and NCD-SSB neighbour cell measurements. The detail signalling design is up to RAN2.

### Definition of Intra-Frequency Measurement

### Issue 3-1-6: The Reference SSB to UE to Perform Intra-Frequency Measurement

Option 1: Network indicates the reference SSB to UE to perform intra-frequency measurements, such as NCD-SSB or CD-SSB.

Option 2: The reference SSB of serving cell for UE to perform intra-frequency measurements should be CD-SSB.

Option 3: The reference SSB of serving cell for UE to perform intra-frequency measurements could be CD-SSB or NCD-SSB. No network indication is needed.

### Issue 3-1-7: If RRM Measurement on Neighbour Cell can be Based on NCD-SSB, Intra-Frequency and Inter-Frequency Measurement Definition for NCD-SSB

Option 1: For RedCap UE supporting NCD-SSB measurement, a measurement is defined as a SSB based intra-frequency measurement provided the centre frequency of reference SSB of serving cell (depending on issue 3-1-6) and the centre frequency of the target SSB of the neighbour cell indicated for measurement are the same, and the subcarrier spacing of the two SSBs are also the same.

Option 2: For RedCap UE supporting NCD-SSB measurement, a measurement is defined as a SSB based intra-frequency measurement provided the centre frequency of the CD-SSB or NCD-SSB of the serving cell indicated for measurement and the centre frequency of the target SSB of the neighbour cell indicated for measurement are the same. The subcarrier spacing of the two SSBs are also the same.

One of the possible methods is to reuse the definition as non-RedCap UE to use CD-SSB to define the intra-frequency measurements. However, the definition is not reasonable for Case B-1 where both serving cell and neighbour cells have NCD-SSB in the active BWP. If we follow the definition to use CD-SSB to define the intra-frequency, it could be found that sub-scenario 1-2 in Case B-1 will be defined as inter-frequency.

Another possible method is to use the SSB in RedCap active BWP to define the intra-frequency measurements. However, RedCap UE is similar as non-RedCap UE which may not have SSB in active BWP. Thus, it's better to define the intra-frequency measurements for RedCap UE based a flexible definition for different SSB configurations based on NW's indication. If NW configures NCD-SSB measurement for serving cell, the intra-frequency measurement shall be defined based on the center frequency of NCD-SSB. Otherwise, the intra-frequency measurement shall be defined based on the center frequency of CD-SSB.

Therefore, when network configures the measurements, network can also indicate the reference SSB for intra-frequency measurement.

Proposal 3: Network indicates the reference SSB to UE to perform intra-frequency measurements, such as NCD-SSB or CD-SSB.

Proposal 4: For RedCap UE, a measurement is defined as an SSB based intra-frequency measurement provided the
If NW configures NCD-SSB of the serving cell indicated for measurement, the centre frequency of the NCD-SSB of the serving cell indicated for measurement and the centre frequency of the target SSB of the neighbour cell indicated for measurement are the same.
Otherwise, the centre frequency of the CD-SSB of the serving cell indicated for measurement and the centre frequency of the target SSB of the neighbour cell indicated for measurement are the same.
The subcarrier spacing of the two SSBs are also the same.
   Serving Cell Measurement with Both NCD-SSB and CD-SSB Configuration
   Issue 3-1-8: Serving Cell Measurement when Both CD-SSB and NCD-SSB Measurements are Configured to the UE

Option 1: If both CD-SSB and NCD-SSB measurement are configured to RedCap UE but both of them need MG, UE could choose to perform CD-SSB measurement only.

Option 2: If both CD-SSB and NCD-SSB measurement are configured to RedCap UE, UE should perform the measurements for both SSB based on NW's configuration.

Option 3: If both CD-SSB and NCD-SSB measurement are configured to RedCap UE, UE should perform serving cell measurements based on SSB with active BWP.

Firstly, in most scenarios, we don't think NW will configure both CD-SSB and NCD-SSB measurements for serving cell. As we mentioned above, the total possible NW scenarios are Case A, B-1, B-2, C. In Case A, the active BWP has CD-SSB, NW will configure CD-SSB measurement for serving cell. In Case B-1, the active BWP for both serving cell and neighbour cell have NCD-SSB, NW will configure NCD-SSB measurement for serving cell. In Case C, the active BWP has no SSB, NW had to configure CD-SSB measurement with gap for serving cell. In Case B-2, NW may configure both CD-SSB and NCD-SSB since UE only can perform neighbour cell measurement based on CD-SSB in some neighbour cells. In this case, UE should perform serving cell measurements based on NCD-SSB within active BWP without gap provided that the difference of center frequency between NCD-SSB and CD-SSB is no larger than 20 MHz in FR1 and 100 MHz in FR2, the periodicity of NCD-SSB and CD-SSB is the same and the transmission power difference is less than 3 dB. Otherwise, UE should perform serving cell measurements based on both NCD-SSB and CD-SSB.

Observation 2: NW may configure both CD-SSB and NCD-SSB serving cell measurement only when some neighbour cells don't transmit NCD-SSB.

Proposal 5: When both CD-SSB and NCD-SSB serving cell measurement are configured, UE should perform serving cell measurements based on NCD-SSB within active BWP provided that
the difference of center frequency between NCD-SSB and CD-SSB is no larger than 20 MHz in FR1 and 100 MHz in FR2
the difference of reception power between NCD-SSB and CD-SSB is less than 3 dB
the periodicity of NCD-SSB and CD-SSB is the same

Otherwise, UE should perform serving cell measurements based on both NCD-SSB and CD-SSB.

Neighbour Cell Measurement with Both NCD-SSB and CD-SSB Configuration
Issue 3-1-9: If RRM measurement on neighbour cell can be based on NCD-SSB, neighbour cell measurement when both CD-SSB and NCD-SSB measurements are configured to the UE

This issue depends on the outcome of issue 3-1-4.

FFS: When NW configures MOs with both CD-SSB and NCD-SSB measurements, UE should follow NW's configuration to perform measurements.

When NW configures neighbour cell measurement with both CD-SSB and NCD-SSB measurements, if the magnitude of the difference between center frequency of CD-SSB and NCD-SSB is no larger than 20 MHz in FR1 and 100 MHz in FR2, the measurement information reporting by UE will be the similar. Thus, UE can perform the neighbour cell measurement based on the SSB without gap or any of them if both need gaps. Otherwise, UE should perform neighbour cell measurements based on both NCD-SSB and CD-SSB.

Proposal 6: When both CD-SSB and NCD-SSB measurement are configured, UE should perform neighbour cell measurements based on SSB without gap or any of them if both need gaps provided that
the difference of center frequency between NCD-SSB and CD-SSB is no larger than 20 MHz in FR1 and 100 MHz in FR2
the difference of reception power between NCD-SSB and CD-SSB is less than 3 dB
the periodicity of NCD-SSB and CD-SSB is the same

Otherwise, UE should perform neighbour cell measurements for both NCD-SSB and CD-SSB.

Proposal 7: RedCap UE needs to report the RRM measurement result together with the type of RS, either NCD-SSB or CD-SSB.

### Measurement Procedures

In Rel-17 RedCap UE, anew NCD-SSB mechanism is introduced.

Issue 3-1-13: On Requirements when NCD-SSB is Configured

Option 1: RAN4 to introduce the new measurement delay requirements for RedCap UE (Ericsson)
Cell detection+CD-SSB measurement reporting+NCD-SSB status detection
Cell detection+NCD-SSB measurement reporting
NCD-SSB measurement for a known cell

Option 2: no need

Option 3: FFS

The total cell identification/measurement delay requirement will be different because of different type of measurement RSs is applied. Therefore, the new delay requirements will be introduced for RedCap UE, such as
Cell identification and measurement by NCD-SSB (Case B-1)
Cell identification and measurement when both NCD-SSB and CD-SSB are configured (Case B-2)

Proposal 8: RAN4 to introduce the new measurement delay requirements for RedCap UE.
(Case B-1) Cell identification and measurement by NCD-SSB
(Case B-2) Cell identification and measurement when both NCD-SSB and CD-SSB are configured

### Issue 3-1-14: NCD-SSB Impact on Non-RedCap UE

Option 1: In Rel-17, Non-RedCap UE may support the new capability of NCD-SSB transmission status detection.

Option 2: Changes/impact on non-RedCap UE are not expected

Option 3: up to RAN1/2 decision

Furthermore, except the RedCap UE, non-RedCap UE may also know whether the NCD-SSB is transmitted in the target cell. A possible new capability of NCD-SSB measurement can be introduced for Rel-17 non-RedCap UE. When non-RedCap UE is configured to measure the signal strength (RSRP/RSRQ/RSSI etc.) of a neighbour cell, UE can use NCD-SSB transmission instead of CD-SSB.

Proposal 9: In Rel-17, Non-RedCap UE may support the new capability of NCD-SSB measurement.

### 3. CSSF Design for RedCap UE

In last meeting, there were some discussions on whether permitting inter-frequency without gap in CSSF outside gap for RedCap UE (see R4-2202774, “WF on use of NCD-SSB or CSI-RS for RedCap UE”, CMCC). However, NCD-SSB measurement was not considered in the discussion. When RedCap active BWP includes NCD-SSB and the center frequency of NCD-SSB is the same as the center frequency of NCD-SSB in the target cell, the neighbour cell's measurement will be called as intra-frequency measurement. Therefore, there is no inter-frequency without gap scenario for RedCap UE.

Proposal 10: RedCap UE won't support ‘Inter-frequency without gap’ measurement capability in Rel-17 provided that the intra-frequency measurement is defined based on the NCD-SSB in active BWP, if NW transmits the NCD-SSB.

In Rel-15, CSSF is always set to 1 for PCell measurement to guarantee the mobility of PCell. As we mentioned before, if no NCD-SSB transmission, the intra-frequency measurement will be defined based on CD-SSB. Thus, RedCap UE may highly perform intra-frequency measurement with measurement gap because CD-SSBs being measured may be outside the active BWP due to BW reduction for RedCap UE.

TABLE 2
gap sharing value for NR SA mode

| measGapSharingScheme | Value of X (%) |
|---|---|
| ‘00’ | Equal splitting |
| ‘01’ | 25 |
| ‘10’ | 50 |
| ‘11’ | 75 |

Note:
It is left to UE implementation to determine which measurement gap sharing scheme in the table to be applied, when MeasGapSharingScheme is absent and there is no stored value in the field.

The possible gap sharing indication can be ‘equal splitting’ or ‘25%’ which implies intra-frequency measurement has lower/equal priority with inter-frequency in the measurement gap. However, to guarantee UE's mobility, PCell measurement delays shall be not significantly increased when PCell's measurements are performed within the measurement gap. Since PCell's measurements are not sharing the same scaling factor with other inter-frequencies, the indication of ‘equal splitting’ and ‘25%’ percentage are not expected to be applied frequently from network which means half of the signalling is wasted. Thus, we suggest RAN4 to revisit the design for CSSF within gap or gap sharing scheme to add additional values of measGapSharingScheme factor for RedCap UE.

Proposal 11: RAN4 should add additional values of measGapSharingScheme factor to promote PCell's measurement for RedCap UE.

### 4. CGI Reading Requirements for RedCap

In last meeting, a WF (R4-2202774, “WF on use of NCD-SSB or CSI-RS for RedCap UE”, CMCC) for CGI reading for RedCap UE was agreed.
RAN4 to reuse CGI reading requirement in Rel-16 for at least 2 Rx RedCap UE.
RAN4 to define scheduling restriction for RedCap UE instead of interruption requirement during CGI reading.

### PBCH Simulation Assumptions for CGI Reading

RAN4 to reuse the same simulation assumption as non-RedCap UE for PBCH decoding in TS38.101-4 but with 1 Rx. The generic simulation assumption parameters are in line with those used for SIB1 decoding

### PBCH Decoding Delay for CGI Reading

FFS to following:
   The MIB decoding delay requirement of 1 Rx RedCap UE can be the same as non-RedCap UE for SNR=−3 dB.

### SIB1 Decoding Simulation Assumptions for CGI Reading

RAN4 to reuse the same simulation assumption as non-RedCap UE for SIB1 decoding but with 1 Rx. The generic simulation assumption parameters are in line with those used for PBCH decoding.

### SIB1 Decoding Delay for CGI Reading

FFS to following: 6 samples are needed for 1 Rx RedCap UE to achieve the SIB1 90% successful rate.

In this document, we will discuss on CGI reading requirement for RedCap UE.

### 4.1 General Requirement for CGI Reading

In Rel-16, RAN4 had already defined the delay and interruption requirement for CGI reading in TS 38.133. The basic procedure for CGI reading including AGC retuning, MIB decoding and SIB1 decoding is as follow.

| | | |
|---|---|---|
| AGC | MIB decoding | SIB1 decoding |

### 1 Rx UE

To further evaluate the CGI reading delay for 1 Rx UE, RAN4 shall evaluate the 1 Rx performance for MIB and SIB1 decoding based on the PBCH simulation assumption from TS38.101-4 agreed in Demod session. The MIB decoding performance for 1 Rx and 2 Rx is shown as follow.

TABLE 1
MIB decoding performance for 1Rx and 2Rx (PBCH SNR = −3dB)

| | | | Decoding success rate | | | | |
|---|---|---|---|---|---|---|---|
| SCS | Channel | Rx | 1Sample | 2Samples | 3Samples | 4Samples | 5Samples |
| 15k | AWGN | 2 | 1.00 | 1.00 | 1.00 | 1.00 | 1.00 |
| 15k | TDLA30 | 2 | 0.98 | 1.00 | 1.00 | 1.00 | 1.00 |
| 15k | TDLC300 | 2 | 1.00 | 1.00 | 1.00 | 1.00 | 1.00 |
| 30k | AWGN | 2 | 1.00 | 1.00 | 1.00 | 1.00 | 1.00 |
| 30k | TDLA30 | 2 | 0.99 | 1.00 | 1.00 | 1.00 | 1.00 |
| 30k | TDLC300 | 2 | 1.00 | 1.00 | 1.00 | 1.00 | 1.00 |
| 120k | AWGN | 2 | 1.00 | 1.00 | 1.00 | 1.00 | 1.00 |
| 120k | TDLA30 | 2 | 1.00 | 1.00 | 1.00 | 1.00 | 1.00 |
| 15k | AWGN | 1 | 1.00 | 1.00 | 1.00 | 1.00 | 1.00 |
| 15k | TDLA30 | 1 | 0.80 | 0.96 | 0.99 | 1.00 | 1.00 |
| 15k | TDLC300 | 1 | 0.89 | 0.99 | 1.00 | 1.00 | 1.00 |
| 30k | AWGN | 1 | 1.00 | 1.00 | 1.00 | 1.00 | 1.00 |
| 30k | TDLA30 | 1 | 0.83 | 0.97 | 0.99 | 1.00 | 1.00 |
| 30k | TDLC300 | 1 | 0.92 | 0.99 | 1.00 | 1.00 | 1.00 |
| 120k | AWGN | 1 | 1.00 | 1.00 | 1.00 | 1.00 | 1.00 |
| 120k | TDLA30 | 1 | 0.87 | 0.98 | 1.00 | 1.00 | 1.00 |

Based on our simulation, current MIB decoding delay for 2 Rx non-RedCap UE can be also applied for 1 Rx RedCap UE.

Proposal 12: The MIB decoding delay requirement of 1 Rx RedCap UE can be the same as non-RedCap UE for SNR=−3 dB.

RAN4 can reuse the Rel-16 simulation assumptions for SIB1 decoding of normal UE since gNB will broadcast the same SIB1 information for both non-RedCap UEs and RedCap UEs. The SIB1 decoding performance for 1 Rx and 2 Rx is shown as follow. We have the following observations.

Observation 3: Based on our simulation results for 1 Rx and 2 Rx RedCap UE,
SIB1 decoding performance can achieve 90% for 2 Rx RedCap UE without soft-combining (same observation as Rel-16 CGI reading requirements)
SIB1 decoding performance cannot achieve 90% for 1 Rx RedCap UE without soft-combining
SIB11 decoding performance can achieve 90% for 1 Rx RedCap UE with soft-combining

TABLE 2
SIB1 decoding performance for 1Rx and
2Rx (PDSCH SNR = −4dB)

| | SIB1 decoding success rate | | | | | | | |
|---|---|---|---|---|---|---|---|---|
| Channel | 1 | 2 | 3 | 4 | 5 | 6 | 7 | 8 |
| 2Rx AWGN | 1 | 1 | 1 | 1 | 1 | 1 | 1 | 1 |
| (single | | | | | | | | |
| sample) | | | | | | | | |
| 2Rx | 0.56 | 0.81 | 0.92 | 0.96 | 0.98 | 0.99 | 1 | 1 |
| TDLC300 | | | | | | | | |
| (single | | | | | | | | |
| sample) | | | | | | | | |
| 1Rx AWGN | 0 | 0 | 0 | 0 | 0 | 0 | 0 | 0 |
| (single | | | | | | | | |
| sample) | | | | | | | | |
| 1Rx | 0.07 | 0.13 | 0.19 | 0.25 | 0.30 | 0.35 | 0.39 | 0.44 |
| TDLC300 | | | | | | | | |
| (single | | | | | | | | |
| sample) | | | | | | | | |
| 1Rx AWGN | | 1 | | 1 | | 1 | | 1 |
| (Soft- | | | | | | | | |
| combining | | | | | | | | |
| every 2 | | | | | | | | |
| samples) | | | | | | | | |
| 1Rx | | 0.59 | | 0.83 | | 0.93 | | 0.97 |
| TDLC300 | | | | | | | | |
| (Soft- | | | | | | | | |
| combining | | | | | | | | |
| every 2 | | | | | | | | |
| samples) | | | | | | | | |

Based on our simulation results, 1 Rx RedCap UE cannot achieve the 90% success rate without soft combining. As we know, gNB cannot differentiate the 1 Rx RedCap UE with other UEs. Thus, the SIB1 payload will be the same for all type of UEs. To guarantee the same SIB11 success rate as other type of UEs, soft-combining should be mandatory to 1 Rx RedCap UE. It can be seen that the SIB1 decoding delay for 1 Rx RedCap UE can be the same as legacy non-RedCap UEs with 6 samples.

Proposal 13: 6 samples are needed for 1 Rx RedCap UE to achieve the SIB1 90% successful rate.

### 4.2 Assistance Information for CGI Reading

There are two main usages for CGI reading:
Identify the target cell by the global ID during handover
ANR to relieve the burden of operators

NCD-SSB will be used for L3 measurement, L1 measurement and mobility for RedCap UE. It's important for serving cell to know the information to further configure the L3 measurements or handover command with NCD-SSB to UEs.

Once serving cell knows NCD-SSB is transmitted in target cell, serving cell can configure the handover command directly to the specific RedCap BWP. In addition, when serving cell manages the newly detected neighbour cells for ANR, it's also beneficial to know whether NCD-SSB is transmitted in the neighbour cells.

However, based on RAN1 and RAN plenary agreements in [3, 4], transmission of NCD-SSB in the target cell is uncertain. Therefore, we propose that if indicated by network, UE will further report the NCD-SSB information (such as SSB-frequency, SCS etc.) together with global cell ID when UE reporting the CGI. Additional delay of the NCD-SSB detection procedure may be expected.

For a separate initial DL BWP (if it does not include CD-SSB and the entire CORESET #0) from RAN1 perspective,
If it is configured for random access while not for paging in idle/inactive mode, RedCap UE does NOT expect it to contain SSB/CORESET #0/SIB.
Note: RAN1 assumes REDCAP UE performing Random access in the separate DL BWP does not need to monitor paging in a BWP containing CORESET #0
Working assumption: If it is configured for paging, RedCap UE expects it to contain NCD-SSB for serving cell but not CORESET #0/SIB from RAN1 perspective

For an RRC-configured active DL BWP in connected mode (if it does not include CD-SSB and the entire CORESET #0) from RAN1 perspective,
A RedCap UE supporting mandatory FG 6-1 (but not optional FG 6-1a) expects it to contain NCD-SSB for serving cell but not CORESET #0/SIB
A RedCap UE can indicate the following as optional capability:
   Not need NCD-SSB: A RedCap UE can in addition optionally support relevant operation based on for CSI-RS (working assumption) and/or FG 6-1a by reporting optional capabilities.

Proposal 14: If indicated by network, UE will further report the NCD-SSB information (such as SSB-frequency, SCS etc.) together with global cell ID when UE reporting the CGI.

### 5. Summary

In the document, we have discussed the CONNECTED mode measurement procedures due to UE complexity reduction for RedCap UE. Based on the discussions, we have made following proposals:

Observation 1: In Rel-15, the intra-frequency measurement definition for non-RedCap UE is based on the center frequency of the SSB between serving cell and the cell to-be-measured.

Observation 2: NW may configure both CD-SSB and NCD-SSB serving cell measurement only when some neighbour cells don't transmit NCD-SSB.

Observation 3: Based on our simulation results for 1 Rx and 2 Rx RedCap UE,
SIB1 decoding performance can achieve 90% for 2 Rx RedCap UE without soft-combining (same observation as Rel-16 CGI reading requirements)
SIB1 decoding performance cannot achieve 90% for 1 Rx RedCap UE without soft-combining
SIB1 decoding performance can achieve 90% for 1 Rx RedCap UE with soft-combining

Proposal 1: RAN4 to discuss RedCap UE's behaviour based on the following scenarios:
Case A: Serving cell active BWP with CD-SSB
Case B: Serving cell active BWP with NCD-SSB
   Case B-1: All neighbour cells with NCD-SSB
   Case B-2: Some neighbour cells with NCD-SSB, some neighbour cells without NCD-SSB
Case C: Serving cell active BWP without SSB

Proposal 2: RAN4 to define requirement for both CD-SSB and NCD-SSB neighbour cell measurements. The detail signalling design is up to RAN2.

Proposal 3: Network indicates the reference SSB to UE to perform intra-frequency measurements, such as NCD-SSB or CD-SSB.

Proposal 4: For RedCap UE, a measurement is defined as an SSB based intra-frequency measurement provided the
If NW configures NCD-SSB of the serving cell indicated for measurement, the centre frequency of the NCD-SSB of the serving cell indicated for measurement and the centre frequency of the target SSB of the neighbour cell indicated for measurement are the same.
Otherwise, the centre frequency of the CD-SSB of the serving cell indicated for measurement and the centre frequency of the target SSB of the neighbour cell indicated for measurement are the same.
The subcarrier spacing of the two SSBs are also the same.

Proposal 5: When both CD-SSB and NCD-SSB serving cell measurement are configured, UE should perform serving cell measurements based on NCD-SSB within active BWP provided that
the difference of center frequency between NCD-SSB and CD-SSB is no larger than 20 MHz in FR1 and 100 MHz in FR2
the difference of reception power between NCD-SSB and CD-SSB is less than 3 dB
the periodicity of NCD-SSB and CD-SSB is the same Otherwise, UE should perform serving cell measurements based on both NCD-SSB and CD-SSB.

Proposal 6: When both CD-SSB and NCD-SSB measurement are configured, UE should perform neighbour cell measurements based on SSB without gap or any of them if both need gaps provided that
the difference of center frequency between NCD-SSB and CD-SSB is no larger than 20 MHz in FR1 and 100 MHz in FR2
the difference of reception power between NCD-SSB and CD-SSB is less than 3 dB
the periodicity of NCD-SSB and CD-SSB is the same

Otherwise, UE should perform neighbour cell measurements for both NCD-SSB and CD-SSB.

Proposal 7: RedCap UE needs to report the RRM measurement result together with the type of RS, either NCD-SSB or CD-SSB.

Proposal 8: RAN4 to introduce the new measurement delay requirements for RedCap UE.
(Case B-1) Cell identification and measurement by NCD-SSB
(Case B-2) Cell identification and measurement when both NCD-SSB and CD-SSB are configured

Proposal 9: In Rel-17, Non-RedCap UE may support the new capability of NCD-SSB measurement.

Proposal 10: RedCap UE won't support ‘Inter-frequency without gap’ measurement capability in Rel-17 provided that the intra-frequency measurement is defined based on the NCD-SSB in active BWP, if NW transmits the NCD-SSB.

Proposal 11: RAN4 should add additional values of measGapSharingScheme factor to promote PCell's measurement for RedCap UE.

Proposal 12: The MIB decoding delay requirement of 1 Rx RedCap UE can be the same as non-RedCap UE for SNR=−3 dB.

Proposal 13: 6 samples are needed for 1 Rx RedCap UE to achieve the SIB1 90% successful rate.

Proposal 14: If indicated by network, UE will further report the NCD-SSB information (such as SSB-frequency, SCS etc.) together with global cell ID when UE reporting the CGI.

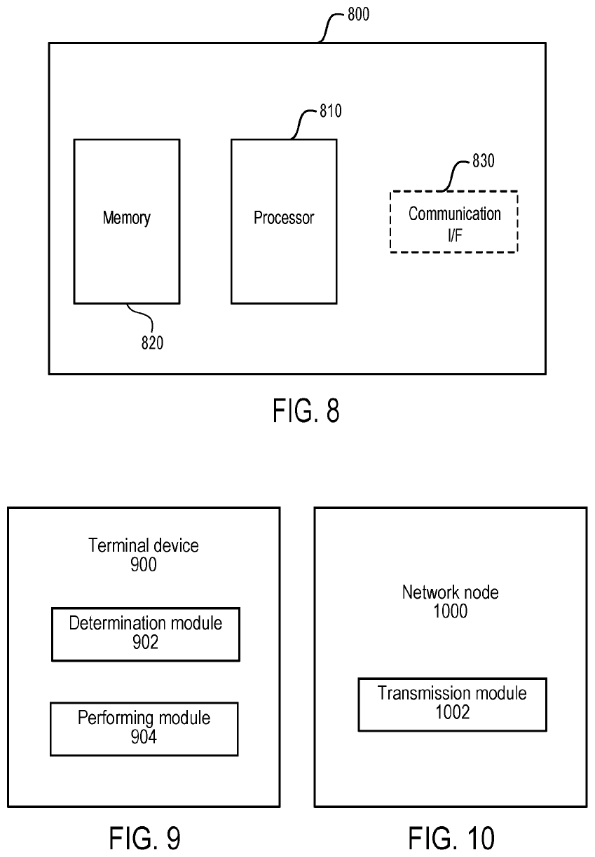

FIG. 8 is a block diagram showing an apparatus suitable for use in practicing some embodiments of the disclosure. For example, any one of the terminal device and the network node described above may be implemented through the apparatus 800. As shown, the apparatus 800 may include a processor 810, a memory 820 that stores a program, and optionally a communication interface 830 for communicating data with other external devices through wired and/or wireless communication.

The program includes program instructions that, when executed by the processor 810, enable the apparatus 800 to operate in accordance with the embodiments of the present disclosure, as discussed above. That is, the embodiments of the present disclosure may be implemented at least in part by computer software executable by the processor 810, or by hardware, or by a combination of software and hardware.

The memory 820 may be of any type suitable to the local technical environment and may be implemented using any suitable data storage technology, such as semiconductor based memory devices, flash memories, magnetic memory devices and systems, optical memory devices and systems, fixed memories and removable memories. The processor 810 may be of any type suitable to the local technical environment, and may include one or more of general purpose computers, special purpose computers, microprocessors, digital signal processors (DSPs) and processors based on multi-core processor architectures, as non-limiting examples.

FIG. 9 is a block diagram showing a terminal device according to an embodiment of the disclosure. As shown, the terminal device 900 comprises a determination module 902 and a performing module 904. The determination module 902 may be configured to determine whether a first downlink BWP and a second downlink BWP are similar to each other in terms of radio configurations, as described above with respect to block 502. The performing module 904 may be configured to perform one or more uplink and/or downlink operational tasks based on a result of the determination, as described above with respect to block 504.

FIG. 10 is a block diagram showing a network node according to an embodiment of the disclosure. As shown, the network node 1000 comprises a transmission module 1002 configured to transmit, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other, as described above with respect to block 602. The modules described above may be implemented by hardware, or software, or a combination of both.

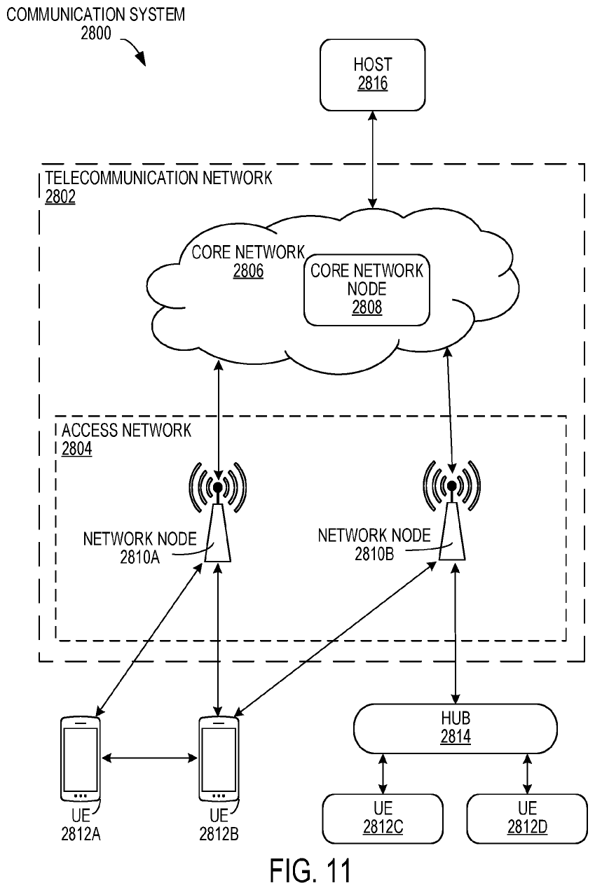

FIG. 11 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs.

Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

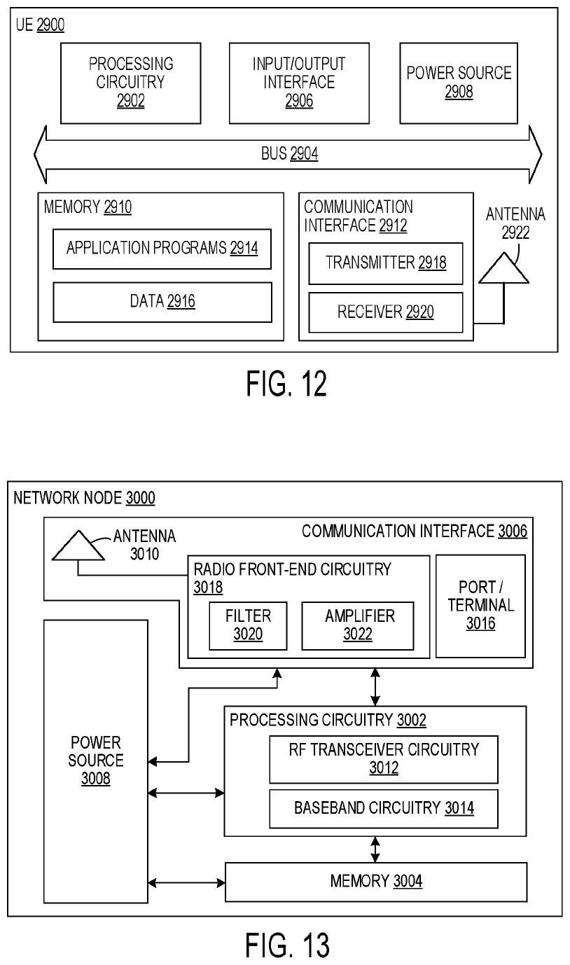

FIG. 12 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 12. The level of integration between the components may vary from one UE to another UE.

Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection.

The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component).

The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 13 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

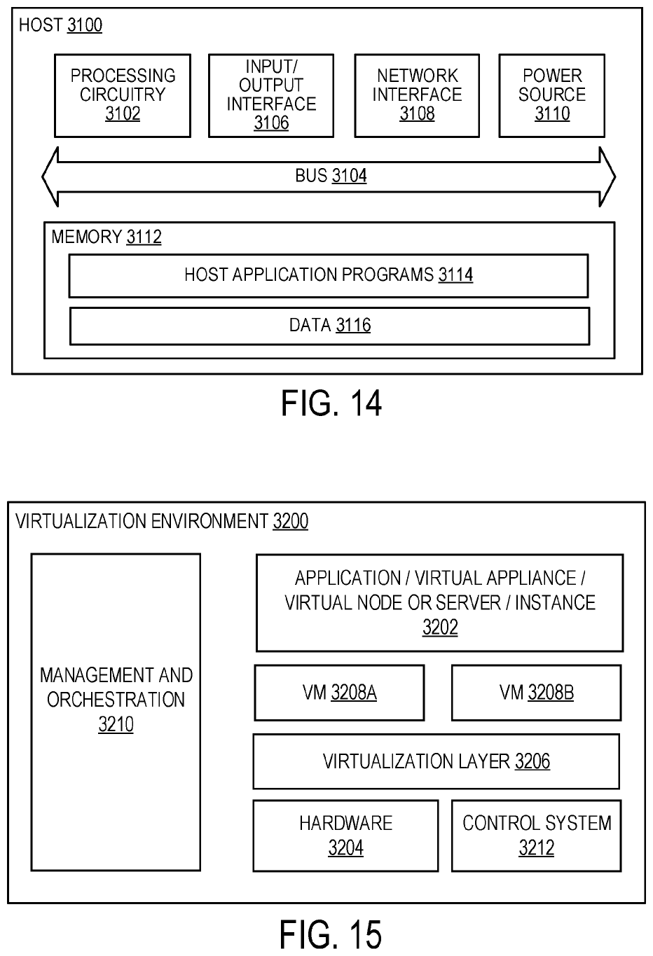

FIG. 14 is a block diagram of a host 3100, which may be an embodiment of the host 2816 of FIG. 11, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 12 and 13, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

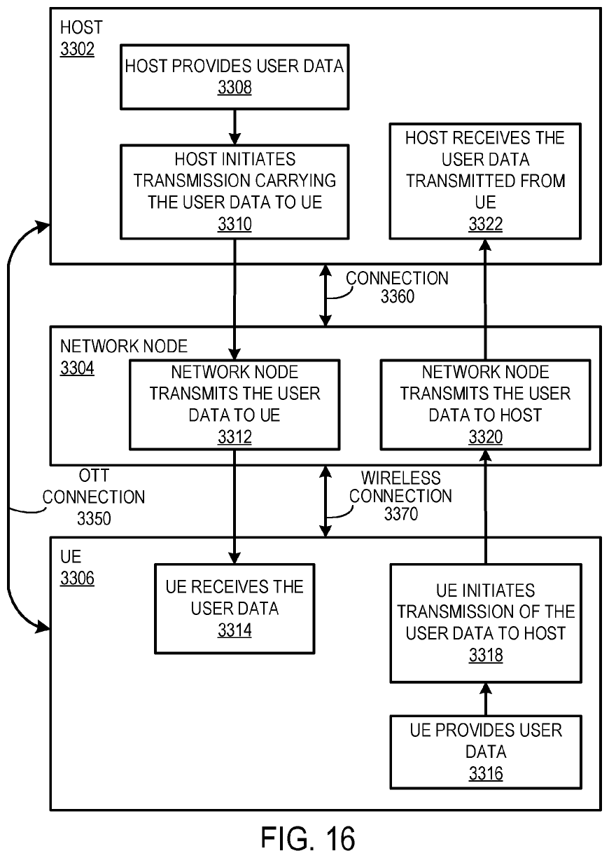

FIG. 16 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 11 and/or UE 2900 of FIG. 12), network node (such as network node 2810a of FIG. 11 and/or network node 3000 of FIG. 13), and host (such as host 2816 of FIG. 11 and/or host 3100 of FIG. 14) discussed in the preceding paragraphs will now be described with reference to FIG. 16.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 11) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices. As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the power consumption and thereby provide benefits such as extended battery lifetime.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

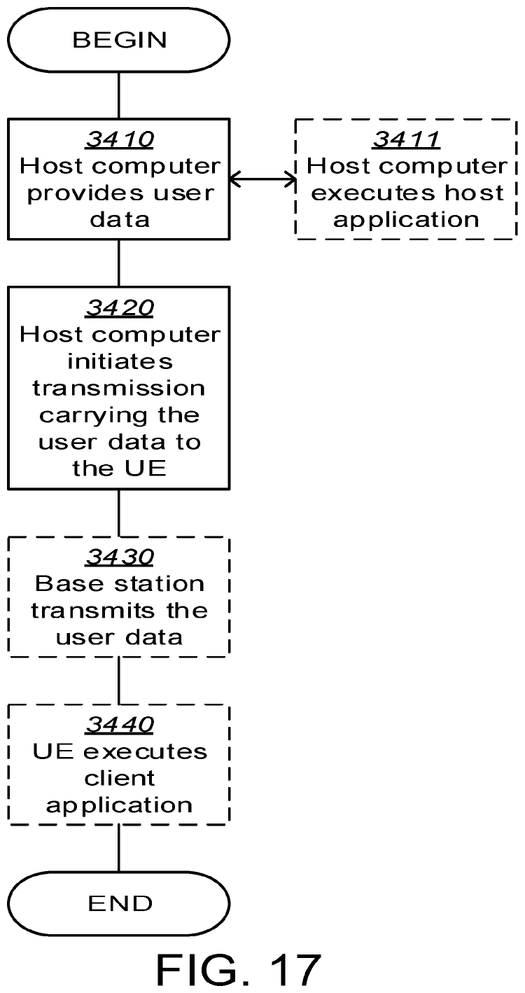

FIG. 17 is a flowchart illustrating a method implemented in a communication system, in accordance with one embodiment. The communication system includes a host computer, a base station and a UE which may be those described with reference to FIGS. 11 and 16. For simplicity of the present disclosure, only drawing references to FIG. 17 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

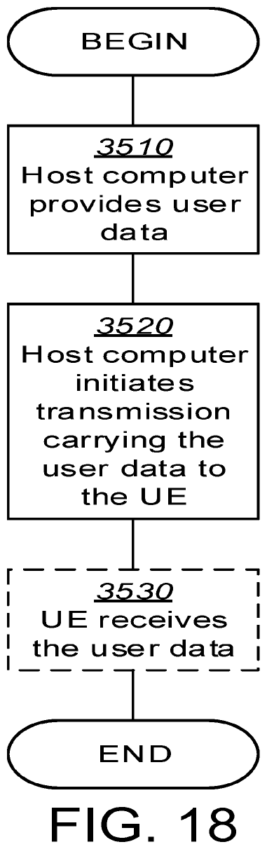

FIG. 18 is a flowchart illustrating a method implemented in a communication system, in accordance with one embodiment. The communication system includes a host computer, a base station and a UE which may be those described with reference to FIGS. 11 and 16. For simplicity of the present disclosure, only drawing references to FIG. 18 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

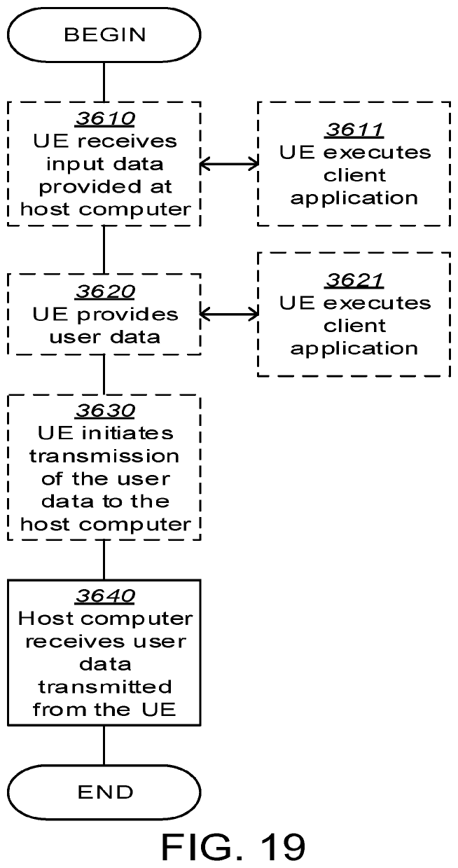

FIG. 19 is a flowchart illustrating a method implemented in a communication system, in accordance with one embodiment. The communication system includes a host computer, a base station and a UE which may be those described with reference to FIGS. 11 and 16. For simplicity of the present disclosure, only drawing references to FIG. 19 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

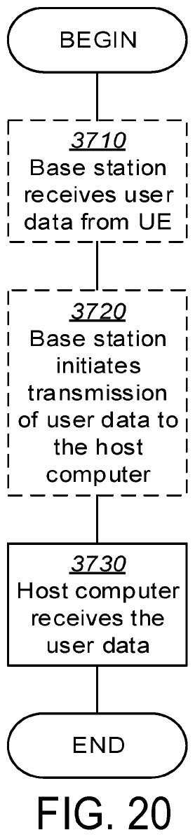

FIG. 20 is a flowchart illustrating a method implemented in a communication system, in accordance with one embodiment. The communication system includes a host computer, a base station and a UE which may be those described with reference to FIGS. 11 and 16. For simplicity of the present disclosure, only drawing references to FIG. 20 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In an aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The base station transmits, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In an embodiment of the disclosure, the method further comprises, at the base station, transmitting the user data.

In an embodiment of the disclosure, the user data is provided at the host computer by executing a host application. The method further comprises, at the terminal device, executing a client application associated with the host application.

In another aspect of the disclosure, there is provided a communication system including a host computer comprising processing circuitry configured to provide user data and a communication interface configured to forward the user data to a cellular network for transmission to a terminal device. The cellular network comprises a base station having a radio interface and processing circuitry. The base station's processing circuitry is configured to transmit, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In an embodiment of the disclosure, the communication system further includes the base station.

In an embodiment of the disclosure, the communication system further includes the terminal device. The terminal device is configured to communicate with the base station.

In an embodiment of the disclosure, the processing circuitry of the host computer is configured to execute a host application, thereby providing the user data. The terminal device comprises processing circuitry configured to execute a client application associated with the host application.

In yet another aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The terminal device determines whether a first downlink BWP and a second downlink BWP are similar to each other in terms of radio configurations. The terminal device performs one or more uplink and/or downlink operational tasks based on a result of the determination.

In an embodiment of the disclosure, the method further comprises, at the terminal device, receiving the user data from the base station.

In yet another aspect of the disclosure, there is provided a communication system including a host computer comprising processing circuitry configured to provide user data and a communication interface configured to forward user data to a cellular network for transmission to a terminal device. The terminal device comprises a radio interface and processing circuitry. The processing circuitry of the terminal device is configured to determine whether a first downlink BWP and a second downlink BWP are similar to each other in terms of radio configurations. The processing circuitry of the terminal device is further configured to perform one or more uplink and/or downlink operational tasks based on a result of the determination.

In an embodiment of the disclosure, the communication system further includes the terminal device.

In an embodiment of the disclosure, the cellular network further includes a base station configured to communicate with the terminal device.

In an embodiment of the disclosure, the processing circuitry of the host computer is configured to execute a host application, thereby providing the user data. The processing circuitry of the terminal device is configured to execute a client application associated with the host application.

In yet another aspect of the disclosure, there is provided a method implemented in a communication system including a host computer, a base station and a terminal device. The method comprises, at the host computer, receiving user data transmitted to the base station from the terminal device. The terminal device determines whether a first downlink BWP and a second downlink BWP are similar to each other in terms of radio configurations. The terminal device performs one or more uplink and/or downlink operational tasks based on a result of the determination.

In an embodiment of the disclosure, the method further comprises, at the terminal device, providing the user data to the base station.

In an embodiment of the disclosure, the method further comprises, at the terminal device, executing a client application, thereby providing the user data to be transmitted. The method further comprises, at the host computer, executing a host application associated with the client application.

In an embodiment of the disclosure, the method further comprises, at the terminal device, executing a client application. The method further comprises, at the terminal device, receiving input data to the client application. The input data is provided at the host computer by executing a host application associated with the client application. The user data to be transmitted is provided by the client application in response to the input data.

In yet another aspect of the disclosure, there is provided a communication system including a host computer comprising a communication interface configured to receive user data originating from a transmission from a terminal device to a base station. The terminal device comprises a radio interface and processing circuitry.

The processing circuitry of the terminal device is configured to determine whether a first downlink BWP and a second downlink BWP are similar to each other in terms of radio configurations. The processing circuitry of the terminal device is further configured to perform one or more uplink and/or downlink operational tasks based on a result of the determination.

In an embodiment of the disclosure, the communication system further includes the terminal device.

In an embodiment of the disclosure, the communication system further includes the base station. The base station comprises a radio interface configured to communicate with the terminal device and a communication interface configured to forward to the host computer the user data carried by a transmission from the terminal device to the base station.

In an embodiment of the disclosure, the processing circuitry of the host computer is configured to execute a host application. The processing circuitry of the terminal device is configured to execute a client application associated with the host application, thereby providing the user data.

In an embodiment of the disclosure, the processing circuitry of the host computer is configured to execute a host application, thereby providing request data. The processing circuitry of the terminal device is configured to execute a client application associated with the host application, thereby providing the user data in response to the request data.

In yet another aspect of the disclosure, there is provided a method implemented in a communication system including a host computer, a base station and a terminal device. The method comprises, at the host computer, receiving, from the base station, user data originating from a transmission which the base station has received from the terminal device. The base station transmits, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In an embodiment of the disclosure, the method further comprises, at the base station, receiving the user data from the terminal device.

In an embodiment of the disclosure, the method further comprises, at the base station, initiating a transmission of the received user data to the host computer.

In yet another aspect of the disclosure, there is provided a communication system including a host computer comprising a communication interface configured to receive user data originating from a transmission from a terminal device to a base station. The base station comprises a radio interface and processing circuitry. The base station's processing circuitry is configured to transmit, to a terminal device, first information indicating at least one condition under which a first downlink BWP and a second downlink BWP are similar to each other in terms of radio configurations, and/or second information indicating one or more uplink and/or downlink operational tasks to be performed by the terminal device based on whether the first downlink BWP and the second BWP are similar to each other.

In an embodiment of the disclosure, the communication system further includes the base station.

In an embodiment of the disclosure, the communication system further includes the terminal device. The terminal device is configured to communicate with the base station.

In an embodiment of the disclosure, the processing circuitry of the host computer is configured to execute a host application. The terminal device is configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1.-39. (canceled)

40. A method performed by a terminal device, comprising:
determining whether a first downlink bandwidth part, BWP, and a second downlink BWP are similar to each other in terms of radio configurations; and
performing one or more uplink and/or downlink operational tasks based on a result of the determination,
wherein the first downlink BWP and the second downlink BWP are determined to be similar to each other when a first RS is transmitted within the bandwidth of the first downlink BWP and a second RS is transmitted within the bandwidth of the second downlink BWP.

41. The method according to claim 40, wherein the one or more uplink operational tasks are performed within a bandwidth of a second uplink BWP associated with the second downlink BWP, or a first uplink BWP associated with the first downlink BWP, based on the result of the determination.

42. The method according to claim 41, wherein a first set of uplink operational tasks are performed when determining that the first downlink BWP and the second downlink BWP are similar to each other, wherein the first set of uplink operational tasks comprise at least one of:
transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other; and
performing a component of a second predetermined procedure within a third time period, wherein the third time period is shorter than a fourth time period within which the same component of the same second predetermined procedure is performed in a case where the first downlink BWP and the second downlink BWP are not similar to each other.

43. The method according to claim 41, wherein a second set of uplink operational tasks are performed when determining that the first downlink BWP and the second downlink BWP are not similar to each other, wherein the second set of uplink operational tasks comprise at least one of:
transmitting an uplink signal within the bandwidth of the second uplink BWP after measuring a second RS contained in a bandwidth of the second downlink BWP or a first RS contained in a bandwidth of the first downlink BWP; and
transmitting an uplink signal or performing a first predetermined procedure containing the transmission of the uplink signal, within the bandwidth of the second uplink BWP within a second time period, wherein the second time period is longer than a first time period within which the same uplink signal is transmitted or the same first predetermined procedure is performed in a case where the first downlink BWP and the second downlink BWP are similar to each other.

44. The method according to claim 41, wherein a first set of uplink operational tasks are performed when determining that the first downlink BWP and the second downlink BWP are similar to each other, wherein the first set of uplink operational tasks comprise at least one of:
transmitting an uplink signal within the bandwidth of the second uplink BWP without measuring a second RS contained in a bandwidth of the second downlink BWP;
using one of the first RS and the second RS for acquiring timing for transmitting an uplink signal within the bandwidth of the second uplink BWP;
using the first RS for acquire timing for transmitting an uplink signal within the bandwidth of the second uplink BWP if the second downlink BWP does not contain the second RS; and
transmitting an uplink signal within the bandwidth of the second uplink BWP even if the second downlink BWP does not contain the second RS.

45. The method according to claim 41, wherein the first uplink BWP is an initial uplink BWP, and the second uplink BWP is a non-initial uplink BWP; or
wherein the first uplink BWP is an initial uplink BWP, and the second uplink BWP is a Redcap uplink BWP.

46. The method according to claim 40, wherein a bandwidth of the first downlink BWP contains a first reference signal, RS, and a bandwidth of the second downlink BWP contains a second RS; or
wherein the bandwidth of the first downlink BWP contains the first RS, and the bandwidth of the second downlink BWP contains no RS.

47. The method according to claim 46, wherein each of the first RS and the second RS is a synchronization signal block, SSB; or
wherein the first RS is a cell-defining SSB, CD-SSB, and the second RS is a non-cell-defining SSB, NCD-SSB; or
wherein the first RS is a channel state information reference signal, CSI-RS, and the second RS is an NCD-SSB.

48. The method according to claim 40, wherein the first downlink BWP and the second downlink BWP are determined to be similar to each other when at least one of following conditions is satisfied:
a bandwidth of the first downlink BWP and a bandwidth of the second downlink BWP at least partially overlap with each other in frequency domain;
the bandwidth of the first downlink BWP and the bandwidth of the second downlink BWP are close to each other in frequency domain;
a difference between transmission powers of the first RS and the second RS is within a predetermined threshold power;
the difference between transmission powers of the first RS and the second RS is known to the terminal device;
a transmission periodicity of the first RS and a transmission periodicity of the second RS are the same; and
a difference between the transmission periodicities of the first RS and the second RS is less than or equal to a predetermined threshold time.

49. The method according to claim 48, wherein the bandwidth of the first downlink BWP and the bandwidth of the second downlink BWP are close to each other in frequency domain, when at least one of following conditions is satisfied:
a difference in frequency between the first downlink BWP and the second downlink BWP is within a first predetermined threshold;
the difference in frequency between the first downlink BWP and the second downlink BWP is not larger than a second predetermined threshold;
a difference between a frequency related to the first downlink BWP and a frequency related to the second downlink BWP is less than or equal to a third predetermined threshold;
a distance in frequency between the first RS and the second RS is within a fourth predetermined threshold;
the distance in frequency between the first RS and the second RS is not larger than a fifth predetermined threshold; and
a difference between a frequency related to the first RS and a frequency related to the second RS is less than or equal to a sixth predetermined threshold.

50. The method according to claim 40, wherein the first downlink BWP is an initial downlink BWP, and the second downlink BWP is a non-initial downlink BWP; or
wherein the first downlink BWP is an initial downlink BWP, and the second downlink BWP is a reduced capability, Redcap, downlink BWP.

51. A method performed by a network node, comprising:
transmitting, to a terminal device, first information indicating at least one condition under which a first downlink bandwidth part, BWP, and a second downlink BWP are similar to each other in terms of radio configurations, and/or second information indicating one or more uplink and/or downlink operational tasks to be performed by the terminal device based on whether the first downlink BWP and the second BWP are similar to each other,
wherein the at least one condition comprises that a first RS is transmitted within the bandwidth of the first downlink BWP and a second RS is transmitted within the bandwidth of the second downlink BWP.

52. The method according to claim 51, wherein the one or more uplink operational tasks are to be performed within a bandwidth of a second uplink BWP associated with the second downlink BWP, or a first uplink BWP associated with the first downlink BWP.

53. The method according to claim 52, wherein the one or more uplink operational tasks to be performed when the first downlink BWP and the second downlink BWP are similar to each other, comprise at least one of:
transmitting an uplink signal within the bandwidth of the second uplink BWP without measuring a second RS contained in a bandwidth of the second downlink BWP;
transmitting an uplink signal or performing a first predetermined procedure containing the transmission of the uplink signal, within the bandwidth of the second uplink BWP within a first time period, wherein the first time period is shorter than a second time period within which the same uplink signal is transmitted or the same first predetermined procedure is performed in a case where the first downlink BWP and the second downlink BWP are not similar to each other;
performing a component of a second predetermined procedure within a third time period, wherein the third time period is shorter than a fourth time period within which the same component of the same second predetermined procedure is performed in a case where the first downlink BWP and the second downlink BWP are not similar to each other;
using one of the first RS and the second RS for acquiring timing for transmitting an uplink signal within the bandwidth of the second uplink BWP;
using the first RS for acquire timing for transmitting an uplink signal within the bandwidth of the second uplink BWP if the second downlink BWP does not contain the second RS; and
transmitting an uplink signal within the bandwidth of the second uplink BWP even if the second downlink BWP does not contain the second RS.

54. The method according to claim 52, wherein the first uplink BWP is an initial uplink BWP, and the second uplink BWP is a non-initial uplink BWP; or
wherein the first uplink BWP is an initial uplink BWP, and the second uplink BWP is a Redcap uplink BWP.

55. The method according to claim 51, wherein a bandwidth of the first downlink BWP contains a first reference signal, RS, and a bandwidth of the second downlink BWP contains a second RS; or
wherein the bandwidth of the first downlink BWP contains the first RS, and the bandwidth of the second downlink BWP contains no RS.

56. The method according to claim 55, wherein each of the first RS and the second RS is a synchronization signal block, SSB; or
wherein the first RS is a cell-defining SSB, CD-SSB, and the second RS is a non-cell-defining SSB, NCD-SSB; or
wherein the first RS is a channel state information reference signal, CSI-RS, and the second RS is an NCD-SSB.

57. The method according to claim 51, wherein the at least one condition comprises one or more of:
a bandwidth of the first downlink BWP and a bandwidth of the second downlink BWP at least partially overlap with each other in frequency domain;
the bandwidth of the first downlink BWP and the bandwidth of the second downlink BWP are close to each other in frequency domain;
a difference between transmission powers of the first RS and the second RS is within a predetermined threshold power;
the difference between transmission powers of the first RS and the second RS is known to the terminal device;
a transmission periodicity of the first RS and a transmission periodicity of the second RS are the same; and
a difference between the transmission periodicities of the first RS and the second RS is less than or equal to a predetermined threshold time.

58. The method according to claim 57, wherein the bandwidth of the first downlink BWP and the bandwidth of the second downlink BWP are close to each other in frequency domain, when at least one of following conditions is satisfied:
a difference in frequency between the first downlink BWP and the second downlink BWP is within a first predetermined threshold;
the difference in frequency between the first downlink BWP and the second downlink BWP is not larger than a second predetermined threshold;
a difference between a frequency related to the first downlink BWP and a frequency related to the second downlink BWP is less than or equal to a third predetermined threshold;
a distance in frequency between the first RS and the second RS is within a fourth predetermined threshold;
the distance in frequency between the first RS and the second RS is not larger than a fifth predetermined threshold; and
a difference between a frequency related to the first RS and a frequency related to the second RS is less than or equal to a sixth predetermined threshold.

59. The method according to claim 51, wherein the first downlink BWP is an initial downlink BWP, and the second downlink BWP is a non-initial downlink BWP; or
wherein the first downlink BWP is an initial downlink BWP, and the second downlink BWP is a reduced capability, Redcap, downlink BWP.

60. A terminal device comprising:
at least one processor; and
at least one memory, the at least one memory containing instructions executable by the at least one processor, whereby the terminal device is operative to:
determine whether a first downlink bandwidth part, BWP, and a second downlink BWP are similar to each other in terms of radio configurations; and
perform one or more uplink and/or downlink operational tasks based on a result of the determination,
wherein the terminal device is operative to perform the method according to claim 40.

61. A network node comprising:
at least one processor; and
at least one memory, the at least one memory containing instructions executable by the at least one processor, whereby the network node is operative to:
transmit, to a terminal device, first information indicating at least one condition under which a first downlink bandwidth part, BWP, and a second downlink BWP are similar to each other in terms of radio configurations, and/or second information indicating one or more uplink and/or downlink operational tasks to be performed by the terminal device based on whether the first downlink BWP and the second BWP are similar to each other,
wherein the network node is operative to perform the method according to claim 51.

62. A computer readable storage medium storing thereon instructions which when executed by at least one processor, cause the at least one processor to perform the method according to claim 40.
